(19) United States
(12) Patent Application Publication
(10) Pub. No.: US 2026/0003315 A1
(43) Pub. Date: Jan. 1, 2026

(54) IMAGE FORMING APPARATUS AND IMAGE FORMING METHOD

(71) Applicant: FUJIFILM Business Innovation Corp., Tokyo (JP)

(72) Inventors: Daisuke TANO, Kanagawa (JP); Yoshiteru YAMADA, Kanagawa (JP); Yuka KAWAMOTO, Kanagawa (JP); Misaki KOMURA, Kanagawa (JP)

(73) Assignee: FUJIFILM Business Innovation Corp., Tokyo (JP)

(21) Appl. No.: 19/026,534

(22) Filed: Jan. 17, 2025

(30) Foreign Application Priority Data
Jun. 28, 2024 (JP) 2024-105656

(51) Int. Cl. G03G 21/00

(52) U.S. Cl. CPC G03G 21/0017

(57) ABSTRACT

An image forming apparatus includes an image holder; a charging unit that charges a surface of the image holder; an electrostatic charge image forming unit that forms an electrostatic charge image on the charged surface of the image holder; an electrostatic charge image developing unit that has an electrostatic charge image developing toner containing toner particles and develops the electrostatic image with the electrostatic charge image developing toner to form a toner image, in which the toner particles contain a metal pigment having an average equivalent circle diameter of 5 μm or more and 15 μm or less, an average value of a ratio b/a of a minor axis diameter b to a major axis diameter a in a cross section of the toner particles is 0.5 or more and 0.8 or less, and an average value of an area of the metal pigment in a projection image of the toner particles in a case where the toner particles are viewed from a thickness direction is 0.5 or more and 0.7 or less; a transferring unit that transfers the toner image to a recording medium; and a cleaning unit that has a cleaning blade coming into contact with the surface of the image holder to clean the surface, in which the cleaning blade has a breaking energy of 5000 MPa·% or more and 15000 MPa % or less and has a 100% modulus of 10 MPa or more at a contact portion with the image holder.

### CROSS-REFERENCE TO RELATED APPLICATIONS

This application is based on and claims priority under 35 USC 119 from Japanese Patent Application No. 2024-105656 filed Jun. 28, 2024.

### BACKGROUND

### (i) Technical Field

The present disclosure relates to an image forming apparatus and an image forming method.

### (ii) Related Art

In the related art, an electrophotographic type image forming apparatus (a copying machine, a facsimile machine, a printer, or the like) is required to form an image having photoluminescence. Therefore, toner particles containing a specific pigment having photoluminescence are used.

For example, JP2012-208142A discloses “electrophotographic toner containing at least a binder resin, a colorant, and a release agent, in which the colorant is a metallic pigment, a loss tangent (tan δ) represented by loss elastic modulus (G″)/storage elastic modulus (G′) is 80 to 160 [° C.] in viscoelasticity of the toner, and a peak value of the loss tangent is 3 or more”.

JP2012-032765A discloses “toner in which, in a case where a solid image is formed, a ratio (A/B) of a reflectivity A at a light-receiving angle of +30° to a reflectivity B at a light-receiving angle of −30° is 2 or more and 100 or less, the reflectivity A and the reflectivity B being measured in a case where the image is irradiated with light having an incidence angle of −45° by a goniophotometer”.

In addition, in an image forming apparatus using a toner, a cleaning blade has been used in the related art in order to clean the toner remaining on an image holder.

For example, JP2019-164226A discloses “image forming apparatus including an image carrying member that has a latent image formed thereon and is capable of carrying a toner image, a developing unit that develops the latent image formed on the image carrying member with a toner, and a cleaning unit that includes a blade-shaped elastic member coming into contact with the surface of the image carrying member, in which a friction coefficient Ft/Fn between the image carrying member and the elastic member is 0.85 or more and 1.1 or less, and WRFt (LMH) of a self-excited vibration of a shear force of the elastic member in an LMH band is 1.5 gf or more and 3.5 gf or less”.

### SUMMARY

Aspects of non-limiting embodiments of the present disclosure relate to provide an image forming apparatus and an image forming method, in which, even in a case of using an electrostatic charge image developing toner that contains toner particles containing a metal pigment having an average equivalent circle diameter of 5 μm or more and 15 μm or less, in which an average value of a ratio b/a of a minor axis diameter b to a major axis diameter a in a cross section is 0.5 or more and 0.8 or less and an average value of an area of the metal pigment in a projection image of the toner particles in a case of being viewed from a thickness direction is 0.5 or more and 0.7 or less, cleaning ability of a cleaning blade to the toner particles is improved and occurrence of toner filming caused by the cleaning blade is suppressed, as compared with an image forming apparatus using a cleaning blade that satisfies at least one of a condition in which a breaking energy is more than 5000 MPa·% or less than 15000 MPa·% or a condition in which a 100% modulus is less than 10 MPa at a contact portion with an image holder.

Aspects of certain non-limiting embodiments of the present disclosure address the above advantages and/or other advantages not described above. However, aspects of the non-limiting embodiments are not required to address the advantages described above, and aspects of the non-limiting embodiments of the present disclosure may not address advantages described above.

Methods for achieving the above-described object include the following.

According to an aspect of the present disclosure, there is provided an image forming apparatus including: an image holder; a charging unit that charges a surface of the image holder; an electrostatic charge image forming unit that forms an electrostatic charge image on the charged surface of the image holder; an electrostatic charge image developing unit that has an electrostatic charge image developing toner containing toner particles and develops the electrostatic image with the electrostatic charge image developing toner to form a toner image, in which the toner particles contain a metal pigment having an average equivalent circle diameter of 5 μm or more and 15 μm or less, an average value of a ratio b/a of a minor axis diameter b to a major axis diameter a in a cross section of the toner particles is 0.5 or more and 0.8 or less, and an average value of an area of the metal pigment in a projection image of the toner particles in a case where the toner particles are viewed from a thickness direction is 0.5 or more and 0.7 or less; a transferring unit that transfers the toner image to a recording medium; and a cleaning unit that has a cleaning blade coming into contact with the surface of the image holder to clean the surface, in which the cleaning blade has a breaking energy of 5000 MPa·% or more and 15000 MPa·% or less and has a 100% modulus of 10 MPa or more at a contact portion with the image holder.

### BRIEF DESCRIPTION OF THE DRAWINGS

Exemplary embodiment(s) of the present invention will be described in detail based on the following figures, wherein:

FIG. 1 is a cross-sectional view schematically showing toner particles used in the present exemplary embodiment;

FIG. 2 is a schematic cross-sectional view showing an example of a layer configuration of an electrophotographic photoreceptor used in the present exemplary embodiment;

FIG. 3 is a view schematically showing the configuration of an example of an image forming apparatus according to the present exemplary embodiment; and

FIG. 4 is a view schematically showing a configuration of another example of the image forming apparatus according to the present exemplary embodiment.

### DETAILED DESCRIPTION

Hereinafter, the present exemplary embodiment as an example of the present disclosure will be described. The following descriptions and examples merely illustrate the exemplary embodiments, and do not limit the scope of the exemplary embodiments.

Regarding the numerical ranges described in stages in the present exemplary embodiments, the upper limit or lower limit of a numerical range may be replaced with the upper limit or lower limit of another numerical range described in stages. Furthermore, in the present exemplary embodiments, the upper limit or lower limit of a numerical range may be replaced with values described in examples.

In the present exemplary embodiment, the term “step” includes not only an independent step but a step which is not clearly distinguished from other steps as long as the intended purpose of the step is achieved.

In the present exemplary embodiment, in a case where an exemplary embodiment is described with reference to drawings, the configuration of the exemplary embodiment is not limited to the configuration shown in the drawings. In addition, the sizes of members in each drawing are conceptual and do not limit the relative relationship between the sizes of the members.

In the present exemplary embodiments, each component may include a plurality of corresponding substances. In a case where the amount of each component in a composition is mentioned in the present exemplary embodiments, and there are two or more kinds of substances corresponding to each component in the composition, unless otherwise specified, the amount of each component means the total amount of two or more kinds of the substances present in the composition.

### Image Forming Apparatus

The image forming apparatus according to the present exemplary embodiment includes an image holder, a charging unit, an electrostatic charge image forming unit, an electrostatic charge image developing unit, a transferring unit, and a cleaning unit. The charging unit charges a surface of the image holder. The electrostatic charge image forming unit forms an electrostatic charge image on the charged surface of the image holder. The electrostatic charge image developing unit has an electrostatic charge image developing toner containing toner particles. The electrostatic charge image developing unit develops the electrostatic image with the electrostatic charge image developing toner to form a toner image. The transferring unit transfers the toner image to a recording medium. The cleaning unit has a cleaning blade that comes into contact with the surface of the image holder to clean the surface.

The toner particles contain a metal pigment having an average equivalent circle diameter of 5 μm or more and 15 μm or less. In the toner particles, an average value of a ratio b/a of a minor axis diameter b to a major axis diameter a in a cross section thereof is 0.5 or more and 0.8 or less. In the toner particles, an average value of an area of the metal pigment in a projection image of the toner particles being viewed from a thickness direction is 0.5 or more and 0.7 or less. Hereinafter, the toner particles satisfying these requirements are referred to as “photoluminescent toner particles”.

The cleaning blade has a breaking energy of 5000 MPa % or more and 15000 MPa·% or less. The cleaning blade has a 100% modulus of 10 MPa or more at a contact portion with the image holder. Hereinafter, the cleaning blade satisfying these requirements is referred to as “specific cleaning blade”.

With the above-described configuration, the image forming apparatus according to the present exemplary embodiment can improve cleaning ability of the cleaning blade to the toner particles. In addition, occurrence of toner filming by the cleaning blade is suppressed. The reason is presumed as follows.

In the related art, in image formation using a toner, it has been required to form an image having brightness (that is, photoluminescence) such as metallic glossiness. Therefore, an electrostatic charge image developing toner containing a metal pigment having a large equivalent circle diameter in toner particles is used. The fact that the equivalent circle diameter is large specifically means that an average equivalent circle diameter is 5 μm or more and 15 μm or less. In addition, in the photoluminescent toner particles in the present exemplary embodiment, the average value of the ratio b/a and the average value of the area of the metal pigment in the projection image of the toner particles in a case of being viewed from the thickness direction are within the above-described ranges. That is, since a shape of the photoluminescent toner particles is flat, an image with more excellent photoluminescence is formed.

However, the above-described photoluminescent toner particles have a flat shape, and thus have deteriorated cleaning ability (that is, are difficult to clean) from a surface of an image holder. On the other hand, for example, a method of strongly pressing the cleaning blade against the image holder to improve the cleaning ability to the toner particles is considered. However, in a case where a pressing force of the cleaning blade is increased, the cleaning blade is likely to be chipped in a low-temperature and low-humidity environment. In a case where the cleaning blade is chipped, the toner particles slip out. In addition, in a high-temperature and high-humidity environment, the cleaning blade is easily worn, and toner filming is likely to occur with the wear.

Therefore, in the present exemplary embodiment, the specific cleaning blade described above is used. In the specific cleaning blade, the breaking energy and the 100% modulus at the contact portion with the image holder are within the above-described ranges. That is, the specific cleaning blade has enhanced breaking resistance, and even in a case where the pressing force is increased, the breaking is suppressed. In this manner, the pressing force against the surface of the image holder can be increased while suppressing chipping of the cleaning blade in a low-temperature and low-humidity environment. As a result, the toner particles are suppressed from slipping out due to the occurrence of the chipping of the cleaning blade. In addition, the cleaning blade enhances the cleaning ability to the toner particles. Furthermore, abrasion of the blade in a high-temperature and high-humidity environment is suppressed, and the occurrence of toner filming associated with the abrasion is suppressed. Therefore, occurrence of image defects is suppressed by suppressing the toner filming.

As described above, with the image forming apparatus according to the present exemplary embodiment, the cleaning ability of the cleaning blade to the toner particles can be improved. In addition, the occurrence of the toner filming by the cleaning blade is suppressed.

Hereinafter, the configuration of the image forming apparatus according to the present exemplary embodiment will be described in detail.

### Toner

In the present exemplary embodiment, an electrostatic charge image developing toner (also simply referred to as “toner” in the present specification) containing a metal pigment and having the average value of the ratio b/a and the pigment area ratio within the above-described ranges is used. The metal pigment has an average equivalent circle diameter of 5 μm or more and 15 μm or less.

### Average Value of Ratio b/a

In the photoluminescent toner particles, the average value of the ratio b/a of the minor axis diameter b to the major axis diameter a in a cross section thereof is 0.5 or more and 0.8 or less. The average value of the ratio b/a is, for example, preferably 0.55 or more and 0.75 or less, and more preferably 0.6 or more and 0.7 or less.

In a case where the average value of the ratio b/a is less than 0.5, coating property of the metal pigment by the binder resin may be deteriorated. On the other hand, in a case where the average value of the ratio b/a is more than 0.8, photoluminescence of a fixed image may be decreased.

In the present exemplary embodiment, a method of measuring the major axis diameter a and the minor axis diameter b in the cross section of the toner particles is as follows. The toner particles are placed on a smooth surface and vibrated to be dispersed without unevenness. For 1,000 toner particles, by magnifying the toner particles 1,000 times with a color laser microscope “VK-9700” (manufactured by KEYENCE CORPORATION), the maximum thickness is defined as the minor axis diameter b and an equivalent circle diameter of a surface as viewed from above is defined as the major axis diameter a; and an arithmetic average value thereof is calculated.

### Pigment Area Ratio

In the photoluminescent toner particles, the average value of the area of the metal pigment in the projection image of the toner particles in a case where the toner particles are viewed in the thickness direction is also referred to as “pigment area ratio” in the present specification. In the photoluminescent toner particles, the pigment area ratio is 0.5 or more and 0.7 or less. The pigment area ratio is, for example, preferably 0.53 or more and 0.67 or less, and more preferably 0.57 or more and 0.63 or less. In a case where the pigment area ratio is less than 0.5, the photoluminescence of the fixed image may be decreased. In a case where the pigment area ratio is more than 0.7, the coating property of the metal pigment by the binder resin may be deteriorated.

In the present exemplary embodiment, a method of measuring the pigment area ratio is as follows. An arithmetic average of pigment area ratios of 1,000 toner particles obtained as described below is defined as the pigment area ratio in the present exemplary embodiment. The toner particles are dispersed in water using a surfactant. For 1,000 toner particles, a light transmission image obtained by an optical microscope “LABOPHOT2” (manufactured by Nikon Corporation) is subjected to image analysis, an area A of the entire toner and an area B of the photoluminescent pigment portion inside the toner are obtained, and B/A is calculated.

### Ratio (X/Y)

In a case where a solid image is formed with the electrostatic charge image developing toner containing the photoluminescent toner particles, for example, it is desirable that a ratio (X/Y) of a reflectivity X at a light-receiving angle of +30° to a reflectivity Y at a light-receiving angle of −30° is 2 or more and 100 or less, the reflectivity X and the reflectivity Y being measured in a case where the image is irradiated with light having an incidence angle of −45° by a goniophotometer.

The fact that the ratio (X/Y) is 2 or more means that the amount of light reflected to a side (angle+side) opposite to a side on which light is incident is larger than the amount of light reflected to the side (angle−side) on which the light is incident, that is, diffuse reflection of the incident light is suppressed. In a case where the diffuse reflection occurs in which incident light is reflected in various directions, the reflected light appears to be dull in color upon visual observation. Therefore, in a case where the ratio (X/Y) is less than 2, glossiness may not be observed even in a case where the reflected light is visually recognized, and the photoluminescence may be deteriorated.

On the other hand, in a case where the ratio (X/Y) is more than 100, an angle of view in which the reflected light can be visually recognized is excessively narrowed, and a specular reflection light component is large, so that the reflected light may appear dark depending on the angle of view.

The ratio (X/Y) is, for example, more desirably 50 or more and 100 or less, still more desirably 60 or more and 90 or less, and particularly desirably 70 or more and 80 or less.

### Measurement of Ratio (X/Y) by Goniophotometer

Here, first, the incidence angle and the light-receiving angle will be described. In the measurement with the goniophotometer in the present exemplary embodiment, the incidence angle is set to −45°. This is because a measurement sensitivity is high for an image having a wide range of glossiness.

In addition, the light-receiving angle is set to −30° and +30°. This is because the measurement sensitivity is the highest for evaluating an image with brilliance and an image without brilliance.

Next, a method of measuring the ratio (X/Y) will be described.

In the present exemplary embodiment, in a case of measuring the ratio (X/Y), first, “solid image” is formed by the following method. A developer as a sample is filled in a developing machine of DocuCentre-III C7600 manufactured by FUJIFILM Business Innovation Corp., and a solid image with a toner coverage of 4.5 g/m² is formed on recording paper (OK topcoat+paper, manufactured by Oji Paper Co., Ltd.) at a fixing temperature of 190° C. and a fixing pressure of 4.0 kg/cm². The “solid image” refers to an image having a printing rate of 100%

Using a spectroscopic variable angle reflectometer GC5000L manufactured by NIPPON DENSHOKU INDUSTRIES Co., Ltd. as the goniophotometer, incidence light at an incidence angle of −45° is incident on an image area of the formed solid image, and the reflectivity X at a light-receiving angle of +30° and the reflectivity Y at a light-receiving angle of −30° are measured. The reflectivity X and the reflectivity Y are measured at intervals of 20 nm for light having a wavelength in a range of 400 nm to 700 nm, and an average value of the reflectivity at each wavelength is used. From these measurement results, the ratio (X/Y) is calculated.

### Configuration of Toner

From the viewpoint of satisfying the above-described ratio (X/Y), for example, it is desirable that the photoluminescent toner particles satisfy the following requirements (1) and (2).

(1) an average equivalent circle diameter D is longer than an average maximum thickness C of the photoluminescent toner particles.

(2) in a case where a cross section of the photoluminescent toner particles in a thickness direction is observed, the number of metal pigments in which an angle between a major axis direction of the toner in the cross section and a major axis direction of the metal pigment is in a range of −30° to +30° is 60% or more of all metal pigments to be observed.

The average maximum thickness C of the toner corresponds to an arithmetic average of the minor axis diameters b in the cross section of the toner particles. The average equivalent circle diameter D of the toner corresponds to an arithmetic mean of the major axis diameters a in the cross section of the toner particles.

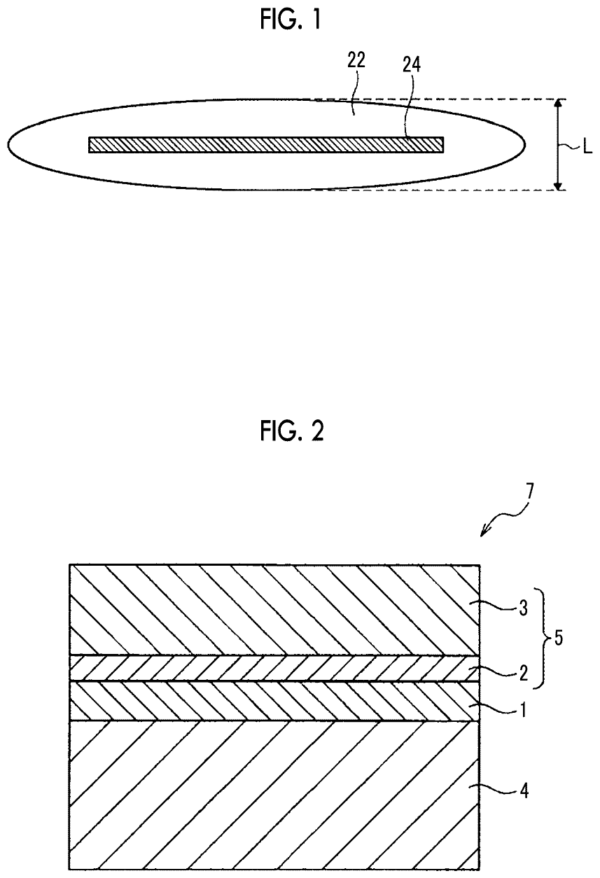

Here, FIG. 1 shows a cross-sectional view schematically showing the photoluminescent toner particle satisfying the above-described requirements (1) and (2). The schematic view shown in FIG. 1 is a cross-sectional view of the photoluminescent toner particle in the thickness direction.

A lustrous toner particle 22 shown in FIG. 1 is flat-shaped toner having an equivalent circle diameter longer than a thickness L, and contains a scale-like metal pigment 24.

As shown in FIG. 1, a case where the photoluminescent toner particle 22 has a flat shape in which the equivalent circle diameter is longer than the thickness Lis considered. In this case, in a developing step or a transferring step of image formation, in a case where the toner moves to an image holder, an intermediate transfer body, a recording medium, or the like, the toner tends to move in a manner of maximally canceling a charge of the toner. Therefore, it is considered that the photoluminescent toner particles are arranged such that an area to be attached is maximized. That is, it is considered that the flat photoluminescent toner particles are arranged on the recording medium to which the toner is finally transferred, such that a flat surface side of the flat photoluminescent toner particles faces the surface of the recording medium. In addition, even in a fixing step of the image formation, it is considered that the flat photoluminescent toner particles are arranged such that the flat surface side of the flat photoluminescent toner particles faces the surface of the recording medium due to pressure during fixing.

Therefore, it is considered that metal pigments satisfying the requirement that “the angle between the major axis direction of the photoluminescent toner particles in the cross section and the major axis direction of the metal pigment is in a range of −30° to +30°” described in (2) above among the scale-like metal pigments contained in the photoluminescent toner particles are arranged such that the surface side having the maximum area faces the surface of the recording medium. In a case where the image thus formed is irradiated with light, it is considered that the above-described ratio (X/Y) is achieved because the proportion of the metal pigment that is irregularly reflected with respect to the incidence light is suppressed. In addition, in a case where the proportion of the metal pigment that diffuses the incidence light is suppressed, the intensity of reflected light changes greatly depending on the viewing angle, and thus more ideal photoluminescence can be obtained.

Next, components constituting the toner used in the present exemplary embodiment will be described.

The toner used in the present exemplary embodiment is configured to contain toner particles, and external additives that are used as necessary.

As the toner particles, the photoluminescent toner particles satisfying the above-described requirements are used. The toner particles are configured to contain, for example, the specific metal pigment, a binder resin, a release agent, and other additives. The binder resin includes, for example, a crystalline resin and an amorphous resin.

### Metal Pigment

The metal pigment used in the photoluminescent toner particles of the present exemplary embodiment is a metal pigment having an average equivalent circle diameter of 5 μm or more and 15 μm or less. In a case where the average equivalent circle diameter of the metal pigment is outside the range of 5 μm or more and 15 μm or less, the photoluminescence of the image may decrease.

The average equivalent circle diameter of the metal pigment is, for example, preferably 7 μm or more and 13 μm or less, and more preferably 9 μm or more and 11 μm or less.

Examples of a component of the metal pigment used in the present exemplary embodiment include the following components. For example, a metal-containing pigment with photoluminescence may be used without particular limitation, and examples thereof include metal powder such as aluminum, brass, bronze, nickel, stainless steel, and zinc; coated flake-like inorganic crystal substrates such as mica coated with titanium oxide or yellow iron oxide, barium sulfate, layered silicate, and layered aluminum silicates; single crystal plate-like titanium oxide, basic carbonates, bismuth oxychloride, and flake-like glass powder subjected to metal vapor deposition. In the present exemplary embodiment, the “photoluminescence” represents that an image formed by the toner of the present exemplary embodiment has brightness such as metallic glossiness in a case where the image is visually recognized.

In the present exemplary embodiment, the average equivalent circle diameter of the metal pigment refers to a value measured as follows.

The metal pigment is placed on a smooth surface and vibrated to be dispersed without unevenness. For 1,000 metal pigments, by magnifying the metal pigments 1,000 times with a color laser microscope “VK-9700” (manufactured by KEYENCE CORPORATION), an equivalent circle diameter D of a surface of the metal pigment as viewed from above is measured, and an arithmetic average value thereof is calculated.

A method of extracting the metal pigment from the toner is not particularly limited. For example, the metal pigment is extracted from the toner by the following method.

The metal pigment is extracted by dispersing the toner in an organic solvent such as toluene to dissolve the binder resin, separating insoluble components with filter paper, and then drying the resultant.

A content of the above-described metal pigment in the toner of the present exemplary embodiment is, for example, preferably 1 part by mass or more and 70 parts by mass or less with respect to 100 parts by mass of the binder resin described later. The content thereof is, for example, more preferably 5 parts by mass or more and 50 parts by mass or less.

### Binder Resin

The toner particles of the present exemplary embodiment may contain a binder resin. As the binder resin, for example, it is preferable to contain a binder resin including a crystalline resin and an amorphous resin.

In the present exemplary embodiment, a proportion of the crystalline resin in the binder resin is, for example, preferably 3% by mass or more and 30% by mass or less. The proportion thereof is, for example, more preferably 5% by mass or more and 25% by mass or less, and still more preferably 10% by mass or more and 20% by mass or less. In a case where the proportion of the crystalline resin in the binder resin is 3% by mass or more, rub resistance of the toner image is improved. In a case where the proportion of the crystalline resin in the binder resin is 30% by mass or less, an increase in the diffuse reflection of the image due to the presence of the crystalline resin is suppressed.

Examples of the binder resin include vinyl-based resins including a homopolymer of a monomer, such as styrenes (for example, styrene, p-chlorostyrene, α-methylstyrene, and the like), (meth)acrylic acid esters (for example, methyl acrylate, ethyl acrylate, n-propyl acrylate, n-butyl acrylate, lauryl acrylate, 2-ethylhexyl acrylate, methyl methacrylate, ethyl methacrylate, n-propyl methacrylate, lauryl methacrylate, 2-ethylhexyl methacrylate, and the like), ethylenically unsaturated nitriles (acrylonitrile, methacrylonitrile, and the like), vinyl ethers (for example, vinyl methyl ether, vinyl isobutyl ether, and the like), vinyl ketones (for example, vinyl methyl ketone, vinyl ethyl ketone, vinyl isopropenyl ketone, and the like), olefins (for example, ethylene, propylene, butadiene, and the like), or a copolymer obtained by combining two or more kinds of monomers described above.

Examples of the binder resin include non-vinyl-based resins such as an epoxy resin, a polyester resin, a polyurethane resin, a polyamide resin, a cellulose resin, a polyether resin, and modified rosin, mixtures of these with the vinyl-based resins, or graft polymers obtained by polymerizing a vinyl-based monomer together with the above resins.

As the binder resin, for example, a polyester resin is suitable.

Examples of the polyester resin include known amorphous polyester resins. As the polyester resin, a crystalline polyester resin may be used in combination with an amorphous polyester resin.

The “crystalline” resin indicates that a clear endothermic peak is present in differential scanning calorimetry (DSC) rather than a stepwise change in endothermic amount and specifically indicates that the half-width of the endothermic peak in a case of measurement at a temperature rising rate of 10 (° C./min) is within 10° C.

On the other hand, the “amorphous” resin indicates that the half-width is higher than 10° C., a stepwise change in endothermic amount is shown, or a clear endothermic peak is not recognized.

### Amorphous Polyester Resin

Examples of the amorphous polyester resin include a polycondensate of a polyvalent carboxylic acid and a polyhydric alcohol. As the amorphous polyester resin, a commercially available product or a synthetic resin may be used.

Examples of the polyvalent carboxylic acid include aliphatic dicarboxylic acids (for example, oxalic acid, malonic acid, maleic acid, fumaric acid, citraconic acid, itaconic acid, glutaconic acid, succinic acid, alkenyl succinic acid, adipic acid, sebacic acid, and the like), alicyclic dicarboxylic acid (for example, cyclohexanedicarboxylic acid and the like), aromatic dicarboxylic acids (for example, terephthalic acid, isophthalic acid, orthophthalic acid, naphthalenedicarboxylic acid, and the like), anhydrides of these, and lower alkyl esters (for example, having 1 or more and 5 or less carbon atoms). Among the polyvalent carboxylic acids, for example, aromatic dicarboxylic acid is preferable.

As the polyvalent carboxylic acid, a carboxylic acid having a valency of 3 or more that has a crosslinked structure or a branched structure may be used in combination with a dicarboxylic acid. Examples of the carboxylic acid having a valency of 3 or more include trimellitic acid, pyromellitic acid, anhydrides of these acids, and lower alkyl esters (for example, having 1 or more and 5 or less carbon atoms) of these acids.

One kind of polyvalent carboxylic acid may be used alone, or two or more kinds of polyvalent carboxylic acids may be used in combination.

Examples of the polyhydric alcohol include aliphatic diols (for example, ethylene glycol, diethylene glycol, triethylene glycol, propylene glycol, butanediol, hexanediol, neopentyl glycol, and the like), alicyclic diols (for example, cyclohexanediol, cyclohexanedimethanol, hydrogenated bisphenol A, and the like), and aromatic diols (for example, an ethylene oxide adduct of bisphenol A, a propylene oxide adduct of bisphenol A, and the like). Among the polyhydric alcohols, for example, an aromatic diol or an alicyclic diol is preferable, and an aromatic diol is more preferable.

As the polyhydric alcohol, a polyhydric alcohol having three or more hydroxyl groups and a crosslinked structure or a branched structure may be used in combination with a diol. Examples of the polyhydric alcohol having three or more hydroxyl groups include glycerin, trimethylolpropane, and pentaerythritol.

One kind of polyhydric alcohol may be used alone, or two or more kinds of polyhydric alcohols may be used in combination.

The glass transition temperature (Tg) of the amorphous polyester resin is, for example, preferably 50° C. or higher and 80° C. or lower, and more preferably 50° C. or higher and 65° C. or lower.

The glass transition temperature is determined from a DSC curve obtained by differential scanning calorimetry (DSC). More specifically, the glass transition temperature is determined by “extrapolated glass transition onset temperature” described in the method for determining a glass transition temperature in JIS K-7121-1987, “Testing methods for transition temperatures of plastics”.

The weight-average molecular weight (Mw) of the amorphous polyester resin is, for example, preferably 5,000 or more and 1,000,000 or less, and more preferably 7,000 or more and 500,000 or less.

The number-average molecular weight (Mn) of the amorphous polyester resin is, for example, preferably 2,000 or more and 100,000 or less.

The molecular weight distribution Mw/Mn of the amorphous polyester resin is, for example, preferably 1.5 or more and 100 or less, and more preferably 2 or more and 60 or less.

The weight-average molecular weight and the number-average molecular weight are measured by gel permeation chromatography (GPC). By GPC, the molecular weight is measured using GPC.HLC-8120GPC manufactured by Tosoh Corporation as a measurement device, TSKgel Super HM-M (15 cm) manufactured by Tosoh Corporation as a column, and tetrahydrofuran (THF) as a solvent. The weight-average molecular weight and the number-average molecular weight are calculated using a molecular weight calibration curve plotted using a monodisperse polystyrene standard sample from the measurement results.

The amorphous polyester resin is obtained by a well-known manufacturing method. Specifically, for example, the polyester resin is obtained by a method of setting a polymerization temperature to 180° C. or higher and 230° C. or lower, reducing the internal pressure of a reaction system as necessary, and carrying out a reaction while removing water or an alcohol generated during condensation.

In a case where monomers as raw materials are not dissolved or compatible at the reaction temperature, in order to dissolve the monomers, a solvent having a high boiling point may be added as a solubilizer. In this case, a polycondensation reaction is carried out in a state where the solubilizer is distilled off. In a case where a monomer with poor compatibility takes part in the copolymerization reaction, for example, the monomer with poor compatibility may be condensed in advance with an acid or an alcohol that is to be polycondensed with the monomer, and then polycondensed together with the main component.

### Crystalline Polyester Resin

Examples of the crystalline polyester resin include a polycondensate of polyvalent carboxylic acid and polyhydric alcohol. As the crystalline polyester resin, a commercially available product or a synthetic resin may be used.

Here, since the crystalline polyester resin easily forms a crystal structure, the crystalline polyester resin is, for example, preferably a polycondensate that is not formed of an aromatic-containing polymerizable monomer but is formed of a linear aliphatic polymerizable monomer.

Examples of the polyvalent carboxylic acid include aliphatic dicarboxylic acids (such as oxalic acid, succinic acid, glutaric acid, adipic acid, suberic acid, azelaic acid, sebacic acid, 1,9-nonanedicarboxylic acid, 1,10-decanedicarboxylic acid, 1,12-dodecanedicarboxylic acid, 1,14-tetradecanedicarboxylic acid, and 1,18-octadecanedicarboxylic acid), aromatic dicarboxylic acids (such as dibasic acids such as phthalic acid, isophthalic acid, terephthalic acid, and naphthalene-2,6-dicarboxylic acid), anhydrides of these dicarboxylic acids, and lower alkyl esters (for example, having 1 or more and 5 or less carbon atoms) of these dicarboxylic acids.

As the polyvalent carboxylic acid, a carboxylic acid having a valency of 3 or more that has a crosslinked structure or a branched structure may be used in combination with a dicarboxylic acid. Examples of the trivalent carboxylic acids include aromatic carboxylic acid (for example, 1,2,3-benzenetricarboxylic acid, 1,2,4-benzenetricarboxylic acid, 1,2,4-naphthalenetricarboxylic acid, and the like), anhydrides of these aromatic carboxylic acids, and lower alkyl esters (for example, having 1 or more and 5 or less carbon atoms) of these aromatic carboxylic acids.

As the polyvalent carboxylic acid, a dicarboxylic acid having a sulfonic acid group or a dicarboxylic acid having an ethylenically double bond may be used together with these dicarboxylic acids.

One kind of polyvalent carboxylic acid may be used alone, or two or more kinds of polyvalent carboxylic acids may be used in combination.

Examples of the polyhydric alcohol include an aliphatic diol (for example, a linear aliphatic diol having 2 or more and 20 or less carbon atoms in a main chain portion). Examples of the aliphatic diol include ethylene glycol, 1,3-propanediol, 1,4-butanediol, 1,5-pentanediol, 1,6-hexanediol, 1,7-heptanediol, 1,8-octanediol, 1,9-nonanediol, 1,10-decanediol, 1,11-undecanediol, 1,12-dodecanediol, 1,13-tridecanediol, 1,14-tetradecanediol, 1,18-octadecanediol, and 1,20-icosanediol. Among the aliphatic diols, for example, 1,6-hexanediol, 1,8-octanediol, 1,9-nonanediol, or 1,10-decanediol is preferable.

As the polyhydric alcohol, an alcohol having a valency of 3 or more, that forms a crosslinked structure or a branched structure, may be used in combination with the diol. Examples of the alcohol having a valency of 3 or more include glycerin, trimethylolethane, and trimethylolpropane, pentaerythritol.

One kind of polyhydric alcohol may be used alone, or two or more kinds of polyhydric alcohols may be used in combination.

Here, the content of the aliphatic diol in the polyhydric alcohol may be 80 mol % or more and, for example, preferably 90 mol % or more.

The melting temperature of the crystalline polyester resin is, for example, preferably 50° C. or higher and 100° C. or lower, more preferably 55° C. or higher and 90° C. or lower, and still more preferably 60° C. or higher and 85° C. or lower.

The melting temperature is determined from a DSC curve obtained by differential scanning calorimetry (DSC) by “peak melting temperature” described in the method for determining the melting temperature in JIS K 7121-1987, “Testing methods for transition temperatures of plastics”.

The weight-average molecular weight (Mw) of the crystalline polyester resin is, for example, preferably 6,000 or more and 35,000 or less.

The crystalline polyester resin can be obtained by a well-known manufacturing method, for example, same as the amorphous polyester resin.

A content of the binder resin with respect to the total amount of the toner particles is, for example, preferably 40% by mass or more and 95% by mass or less, more preferably 50% by mass or more and 90% by mass or less, and still more preferably 60% by mass or more and 90% by mass or less.

### Release Agent

Examples of the release agent include hydrocarbon-based wax; natural wax such as carnauba wax, rice wax, and candelilla wax; synthetic or mineral petroleum-based wax such as montan wax; and ester-based wax such as fatty acid esters and montanic acid esters. The release agent is not limited to the agents.

The melting temperature of the release agent is, for example, preferably 50° C. or higher and 110° C. or lower, and more preferably 60° C. or higher and 100° C. or lower.

The melting temperature is determined from a DSC curve obtained by differential scanning calorimetry (DSC) by “peak melting temperature” described in the method for determining the melting temperature in JIS K-7121-1987, “Testing methods for transition temperatures of plastics”.

The content of the release agent with respect to the total amount of the toner particles is, for example, preferably 1% by mass or more and 20% by mass or less, and more preferably 4% by mass or more and 15% by mass or less.

### Other Additives

Examples of other additives include well-known additives such as a magnetic material, a charge control agent, and an inorganic powder. The additives are incorporated into the toner particles as internal additives.

Characteristics and the like of Photoluminescent Toner Particles

The photoluminescent toner particles may be toner particles that have a single-layer structure or toner particles having a so-called core/shell structure that is configured with a core portion (core particle) and a coating layer (shell layer) coating the core portion.

Here, the toner particles having a core/shell structure may, for example, be configured with a core portion that is configured with the binder resin, the metal pigment (colorant), and other additives used as necessary, such as a release agent, and a coating layer that is configured with the binder resin.

A volume-average particle size (D50v) of the photoluminescent toner particles is, for example, preferably 5 μm or more and 30 μm or less.

Various average particle sizes and various particle size distribution indexes of the toner particles are measured using COULTER MULTISIZER 4e (manufactured by Beckman Coulter, Inc.) and using ISOTON-II (manufactured by Beckman Coulter, Inc.) as an electrolytic solution.

For measurement, a measurement sample in an amount of 0.5 mg or more and 50 mg or less is added to 2 ml of a 5% aqueous solution of a surfactant (for example, preferably sodium alkylbenzene sulfonate) as a dispersant. The obtained solution is added to an electrolytic solution in a volume of 100 ml or more and 150 ml or less.

The electrolytic solution in which the sample is suspended is subjected to a dispersion treatment for 1 minute with an ultrasonic disperser, and the particle size distribution of particles having a particle size in a range of 2 μm or more and 60 μm or less is measured using COULTER MULTISIZER 4e with an aperture having an aperture size of 100 μm. The number of particles to be sampled is 50,000.

For the particle size range (channel) divided based on the measured particle size distribution, a cumulative volume distribution and a cumulative number distribution are plotted from small-sized particles. The particle size at which the cumulative percentage of particles is 16% is defined as volume-average particle size D16v and a number-based particle size D16p. The particle size at which the cumulative percentage of particles is 50% is defined as a volume-average particle size D50v and a cumulative number-average particle size D50p. The particle size at which the cumulative percentage of particles is 84% is defined as volume-average particle size D84v and a number-based particle size D84p.

By using these values, a volume-average particle size distribution index (GSDv) is calculated as (D84v/D16v)^{1/2}, and a number-average particle size distribution index (GSDp) is calculated as (D84p/D16p)^{1/2}.

A shape factor SF1 of the photoluminescent toner particles is, for example, preferably 110 or more and 150 or less, and more preferably 120 or more and 140 or less.

The shape factor SF1 is obtained by the following equation.

$$SF 1 = ( {ML}^{2} / A ) \times ( π / 4 ) \times 100 \qquad Equation$$

In the above equation, ML represents the absolute maximum length of the toner, and A represents the projected area of the toner.

Specifically, the shape factor SF1 is quantified generally by analyzing a microscopic image or a scanning electron microscopic (SEM) image using an image analyzer, and is calculated as follows. That is, the shape factor SF1 is obtained by capturing an optical microscopic image of particles scattered on the surface of a slide glass into a LUZEX image analyzer with a video camera, obtaining the maximum length and the projected area of 100 particles, and calculating with the above-described equation to obtain an average value thereof.

### Angle Between Major Axis Direction of Photoluminescent Toner Particles in Cross Section and Major Axis Direction of Metal Pigment

As shown in (2) above, in a case where a cross section of the photoluminescent toner particles in a thickness direction is observed, for example, it is desirable that the number of metal pigments in which an angle between a major axis direction of the toner particles in the cross section and a major axis direction of the metal pigment is in a range of −30° to +30° is 60% or more of all metal pigments to be observed. Furthermore, the above-described number is, for example, more desirably 70% or more and 95% or less, and particularly desirably 80% or more and 90% or less.

In a case where the above-described number is 60% or more, excellent photoluminescence is obtained.

Here, a method of observing the cross section of the toner particles will be described.

The toner particles are embedded in a bisphenol A-type liquid epoxy resin and a curing agent, and a cutting sample is produced. Next, the cutting sample is cut under-100° C. using a cutting machine using a diamond knife (in the present exemplary embodiment, a LEICA ultramicrotome (manufactured by Hitachi Technologies Corporation) is used), and an observation sample is produced. The cross section of the toner particles in the observation sample is observed with a transmission electron microscope (TEM) at a magnification of approximately 5,000 times. For 1,000 observed toner particles, the number of metal pigments in which the angle between the major axis direction of the toner particles in the cross section and the major axis direction of the metal pigment is in a range of −30° to +30° is counted using image analysis software, and a proportion thereof is calculated.

The “major axis direction of the toner particles in the cross section” represents a direction orthogonal to the thickness direction of the toner particles having an average equivalent circle diameter D longer than the average maximum thickness C described above, and the “major axis direction of the metal pigment” represents a length direction of the metal pigment.

### External Additive

Examples of the external additive include inorganic particles. Examples of the inorganic particles include SiO₂, TiO₂, Al₂O₃, SrTiO₃, CaTiO₃, CuO, ZnO, SnO₂, CeO₂, Fe₂O₃, MgO, BaO, CaO, K₂O, Na₂O, ZrO₂, CaO·SiO₂, K₂O. (TiO₂)ₙ, Al₂O₃·2SiO₂, CaCO₃, MgCO₃, BaSO₄, and MgSO₄.

The surface of the inorganic particles as an external additive may have undergone, for example, a hydrophobization treatment. The hydrophobic treatment is performed, for example, by immersing the inorganic particles in a hydrophobic agent. The hydrophobic agent is not particularly limited, and examples thereof include a silane-based coupling agent, silicone oil, a titanate-based coupling agent, and an aluminum-based coupling agent. One kind of each of the agents may be used alone, or two or more kinds of the agents may be used in combination.

Usually, the amount of the hydrophobic agent is, for example, 1 part by mass or more and 10 parts by mass or less with respect to 100 parts by mass of the inorganic particles.

Examples of the external additive also include resin particles (resin particles such as polystyrene, polymethylmethacrylate (PMMA), and melamine resins), and a cleaning activator (for example, a metal salt of a higher fatty acid represented by zinc stearate, and higher alcohols).

The amount of external additives externally added with respect to the toner particles is, for example, preferably 0.01% by mass or more and 10.0% by mass or less, and more preferably 0.01% by mass or more and 6.0% by mass or less.

The toner of the present exemplary embodiment may be produced by adding an external additive to the toner particles after the toner particles are manufactured.

A method for manufacturing the toner particles is not particularly limited, and the toner particles are produced by a known dry method such as a kneading and pulverization method, a wet method such as a coagulation method, a suspension polymerization method, and a dissolution suspension method, or the like.

The kneading and pulverization method is a method in which each material including the binder resin is mixed, the material is melt-kneaded using a kneader, an extruder, or the like, the obtained melt-kneaded product is coarsely pulverized, and then pulverized with a jet mill or the like, and the toner particles having a target particle diameter are obtained by a wind power classifier.

Among these methods, for example, a coagulation method is desirable because the shape of the toner particles and the particle diameter of the toner particles are easily controlled and the control range of the toner particle structure such as a core-shell structure is wide. In addition, from the viewpoint that the shape of the toner particles and the particle diameter of the toner particles can be easily controlled and the toner resin can be coated on the pigment in a state in which unevenness is suppressed, for example, the coagulation method is desirable.

Hereinafter, a method for manufacturing the toner particles by the coagulation method will be described in detail.

The coagulation method includes an emulsification step of emulsifying raw materials constituting the toner particles to form resin particles (emulsified particles) and the like, an aggregation step of forming an aggregate of the resin particles, and a fusion step of fusing the aggregates.

### Emulsification Step

In production of a resin particle dispersion, in addition to the production of the resin particle dispersion by a general polymerization method, for example, an emulsion polymerization method, a suspension polymerization method, a dispersion polymerization method, or the like, the resin particle dispersion may be produced by emulsifying a solution obtained by mixing an aqueous medium and a binder resin with a disperser to apply a shearing force. In this case, viscosity of the resin component may be lowered by heating to form particles. In addition, a dispersant may be used for stabilizing the dispersed resin particles. Furthermore, in a case where the resin is dissolved in an oily solvent having a relatively low solubility in water, the resin is dissolved in the solvent, and the resin is dispersed in water together with a dispersant or a polymer electrolyte to disperse the resin particles, and then the solvent is evaporated by heating or depressurization, thereby producing the resin particle dispersion.

Examples of the aqueous medium include water such as distilled water and deionized water, and alcohols, but water is desirable.

In addition, examples of the dispersant used in the emulsification step include water-soluble polymers such as polyvinyl alcohol, methyl cellulose, ethyl cellulose, hydroxyethyl cellulose, carboxymethyl cellulose, sodium polyacrylate, and sodium polymethacrylate; anionic surfactants such as sodium dodecylbenzene sulfonate, sodium octadecyl sulfate, sodium oleate, sodium laurate, and potassium stearate; cationic surfactants such as laurylamine acetate, stearylamine acetate, and lauryltrimethylammonium chloride; amphoteric surfactants such as laurydimethylamine oxide; nonionic surfactants such as polyoxyethylene alkyl ether, polyoxyethylene alkylphenyl ether, and polyoxyethylene alkylamine; and inorganic salts such as tricalcium phosphate, aluminum hydroxide, calcium sulfate, calcium carbonate, and barium carbonate.

Examples of the disperser used for the production of the above-described emulsified liquid include a homogenizer, a homomixer, a pressurized kneader, an extruder, and a media disperser. As a size of the resin particles, an average particle diameter (volume-average particle diameter) of the resin particles is, for example, desirably 1.0 μm or less, more desirably in a range of 60 nm or more and 300 nm or less, and still more desirably in a range of 150 nm or more and 250 nm or less. In a case where the average particle diameter thereof is 60 nm or more, the resin particles are likely to be unstable particles in the dispersion, and thus the resin particles may be easily aggregated. In addition, in a case where the average particle diameter thereof is 1.0 μm or less, a particle diameter distribution of the toner may be narrowed.

In preparation of a release agent dispersion, the release agent is dispersed in water together with an ionic surfactant or a polymeric electrolyte such as a polymeric acid and a polymeric base, heated to a temperature equal to or higher than a melting temperature of the release agent, and then subjected to a dispersion treatment using a homogenizer or a pressure jetting type disperser, that applies a strong shearing force. By undergoing such a treatment, a release agent dispersion is obtained. In the dispersion treatment, an inorganic compound such as polyaluminum chloride may be added to the dispersion. Examples of the inorganic compound include polyaluminum chloride, aluminum sulfate, highly basic polyaluminum chloride (BAC), polyaluminum hydroxide, and aluminum chloride. Among the above, for example, polyaluminum chloride, aluminum sulfate, or the like is desirable. The above-described release agent dispersion is used in the coagulation method, but the above-described release agent dispersion may also be used in a case where the toner is manufactured by the suspension polymerization method.

By the dispersion treatment, a release agent dispersion containing release agent particles having a volume-average particle diameter of 1 μm or less is obtained. The volume-average particle diameter of the release agent particles is, for example, more desirably 100 nm or more and 500 nm or less.

In a case where the volume-average particle diameter thereof is 100 nm or more, characteristics of the binder resin to be used are also affected, but the release agent component is generally easily incorporated into the toner. In addition, in a case where the volume-average particle diameter thereof is 500 nm or less, a dispersion state of the release agent in the toner is improved.

A known dispersion method can be used for preparing a colorant (metal pigment) dispersion, and for example, a general dispersion unit such as a rotary shear-type homogenizer, a ball mill, a sand mill, a dynomill, and an ultimizer having a medium can be adopted, and the preparation method is not limited at all. The colorant is dispersed in water together with an ionic surfactant or a polymeric electrolyte such as a polymeric acid and a polymeric base. A volume-average particle diameter of colorant particles to be dispersed may be 20 μm or less, but for example, is desirably in a range of 3 μm or more and 16 μm or less because dispersibility of the colorant in the toner is favorable without impairing aggregating properties.

In addition, a dispersion of the photoluminescent metal pigment coated with the binder resin may be prepared by dispersing and dissolving and mixing the photoluminescent metal pigment and the binder resin in a solvent, and then dispersing the mixture in water by phase transfer emulsification or shear emulsification.

### Aggregation Step

In the aggregation step, the dispersion of the resin particles, the colorant dispersion, the release agent dispersion, and the like are mixed to form a mixed solution, and the mixed liquid is heated at a temperature equal to or lower than a glass transition temperature of the resin particles to be aggregated, thereby forming aggregated particles. The formation of the aggregated particles is usually carried out by making a pH of the mixed solution acidic under stirring. The pH is, for example, desirably in a range of 2 or more and 7 or less, and in this case, it is also effective to use an aggregating agent.

In addition, in the aggregation step, the release agent dispersion may be added and mixed at once with various dispersions such as the resin particle dispersion, or may be added in a plurality of times.

In the aggregation step, for example, by using a stirring blade that forms a laminar flow having two paddles and stirring at a high stirring speed (for example, 500 rpm or more and 1,500 rpm or less), an orientation of the major axis direction of the metal pigment is aligned in the aggregated particles, and the aggregated particles are also aggregated in the major axis direction, and thus a thickness of the toner is reduced (that is, the above-described requirement (1) is satisfied).

As the aggregating agent, a surfactant, an inorganic metal salt, or a di- or higher valent metal complex, having a polarity opposite to the surfactant used in the dispersant described above, is used. In particular, in a case where a metal complex is used, for example, the amount of the surfactant used can be reduced, and the charge characteristics are improved, that is particularly desirable.

As the above-described inorganic metal salt, particularly, for example, an aluminum salt or a polymer thereof is suitable. In order to obtain a narrower particle size distribution, for example, it is more suitable that the valence of the inorganic metal salt is divalent rather than monovalent, trivalent rather than divalent, and tetravalent rather than trivalent; and for example, a polymer of the inorganic metal salt is more suitable even in a case where the valence is the same.

In the present exemplary embodiment, for example, it is desirable to use a polymer of a tetravalent inorganic metal salt containing aluminum in order to obtain the narrow particle size distribution.

In addition, the toner having a configuration in which a surface of core aggregated particles is coated with a resin may be produced by adding the resin particle dispersion thereto in a case where the above-described aggregated particles have a desired particle diameter (coating step). In this case, since the release agent or the colorant is less likely to be exposed to the toner surface, the configuration is, for example, desirable from the viewpoint of chargeability or developability. In a case of the re-addition, the aggregating agent may be added before the re-addition, or pH adjustment may be performed.

### Fusion Step

In the fusion step, the progress of the aggregation is stopped by raising a pH of a suspension of the aggregated particles to a range of 3 or more and 9 or less under stirring conditions similar to the conditions in the above-described aggregation step, and the aggregated particles are fused by heating at a temperature equal to or higher than a glass transition temperature of the above-described resin. In addition, in a case of being coated with the above-described resin, the resin also fuses and coats the core aggregated particles. A time of the above-described heating may be long enough to fuse the materials together, and the heating may be performed for approximately 0.5 hours or more and 10 hours or less.

In the fusion step, by fusing the aggregated particles at a lower temperature (for example, 60° C. or higher and 80° C. or lower), movement associated with the re-disposition of the material is reduced, the aligning properties of the pigment are maintained, and thus the toner particles satisfying the above-described requirement (2) are obtained.

After the fusion, the obtained mixture is cooled to obtain fused particles. In addition, in the cooling step, crystallization may be promoted by performing so-called slow cooling in which a cooling rate is lowered in the vicinity of the glass transition temperature of the resin (in a range of the glass transition temperature±10° C.).

The fused particles obtained by the fusion are subjected to a solid-liquid separation step such as filtration, and as necessary a washing step and a drying step to obtain the toner particles.

In order to adjust charge, impart fluidity, impart charge exchange properties, and the like, inorganic oxides such as silica, titania, and aluminum oxide are added and attached as an external additive to the obtained toner particles. The addition can be carried out by, for example, a V-type blender, a Henschel mixer, a Raderger mixer, or the like, and the attachment may be carried out in stages. An amount of the external additive added is, for example, in a range of 0.1 parts or more and 5 parts or less, and more preferably in a range of 0.3 parts or more and 2 parts or less with respect to 100 parts of the toner particles.

Furthermore, as necessary, the coarse particles of the toner may be removed after the external addition, using an ultrasonic sieve shaker, a vibrating sieve shaker, an air sieve shaker, or the like.

In addition to the above-described inorganic oxide and the like, other components (particles) such as a charge control agent, organic particles, a lubricant, and an abrasive may be added as the external additive.

The charge control agent is not particularly limited, but for example, a colorless or light-colored charge control agent is desirably used. Examples thereof include a quaternary ammonium salt compound, a nigrosin-based compound, a complex of aluminum, iron, chromium, or the like, and a triphenylmethane-based pigment.

Examples of the organic particles include particles generally used as an external additive on the surface of the toner, such as a vinyl-based resin, a polyester resin, and a silicone resin. These inorganic particles or organic particles are used as a fluidity assistant, a cleaning assistant, or the like.

Examples of the lubricant include fatty acid amides such as ethylene bisstearylamide and oleic acid amide, and fatty acid metal salts such as zinc stearate and calcium stearate. Examples of the abrasive include silica, alumina, cerium oxide, and the like described above.

Next, a method of manufacturing the toner particles by a dissolution suspension method will be described in detail.

In the dissolution suspension method, a material containing the binder resin, the colorant, and other components used as necessary, such as a release agent, is dissolved or dispersed in a solvent capable of dissolving the binder resin. Next, the dissolved or dispersed solution is granulated in an aqueous medium containing an inorganic dispersant, and then the above-described solvent is removed to obtain the toner particles.

Examples of other components used in the dissolution suspension method, in addition to the release agent, include various components such as an internal additive, a static control agent, an inorganic powder (inorganic particles), and organic particles.

In the present exemplary embodiment, the binder resin, the colorant, and the other components used as necessary are dissolved or dispersed in a solvent capable of dissolving the binder resin. Whether or not the binder resin can be dissolved depends on constituent components of the binder resin, a molecular chain length, a degree of three-dimensionalization, and the like, and thus cannot be indiscriminately determined. However, in general, a hydrocarbon such as toluene, xylene, and hexane; a halogenated hydrocarbon such as methylene chloride, chloroform, dichloroethane, and dichloroethylene; an alcohol or an ether such as ethanol, butanol, benzyl alcohol ethyl ether, benzyl alcohol isopropyl ether, tetrahydrofuran, and tetrahydropyrane; an ester such as methyl acetate, ethyl acetate, butyl acetate, and isopropyl acetate; a ketone or an acetal such as acetone, methyl ethyl ketone, diisobutyl ketone, dimethyl oxide, diacetone alcohol, cyclohexanone, and methyl cyclohexanone; or the like is used.

These solvents dissolve the binder resin, and it is not necessary to dissolve the colorant and the other components. The colorant and the other components may be dispersed in the solution of the binder resin. An amount of the solvent used is not limited as long as a viscosity that the granulation can be performed in the aqueous medium is obtained. A ratio of the material containing the binder resin, the colorant, and the other components and the solvent is, for example, preferably 10/90 to 50/50 (mass ratio of the former and the latter) from the viewpoint of ease of granulation and yield of the final toner particles.

A liquid (toner mother liquid) of the binder resin, the colorant, and other components, dissolved or dispersed in the solvent, is granulated to have a predetermined particle diameter in the aqueous medium containing the inorganic dispersant. As the aqueous medium, water is mainly used. A mixing ratio of the aqueous medium and the toner mother liquid is, for example, preferably aqueous medium/toner mother liquid=90/10 to 50/50 (mass ratio). As the inorganic dispersant, for example, a material selected from tricalcium phosphate, hydroxyapatite, calcium carbonate, titanium oxide, or silica powder is preferable. An amount of the inorganic dispersant used is determined according to a particle diameter of the particles to be granulated, but in general, the amount is, for example, preferably used in a range of 0.1% by mass or more and 15% by mass or less with respect to the toner mother liquid. In a case where the amount is less than 0.1% by mass, the granulation may not be performed satisfactorily; and in a case where the amount is more than 15% by mass, unnecessary fine particles may be generated, and the target particles may be obtained with difficulty at a high yield.

In order to satisfactorily granulate the toner mother liquid in the aqueous medium containing the inorganic dispersant, an auxiliary agent may be added to the aqueous medium. Examples of such an auxiliary agent include known cationic, anionic, or nonionic surfactants, and anionic surfactants are particularly preferable. Examples thereof include sodium alkylbenzene sulfonate, sodium α-olefin sulfonate, and sodium alkyl sulfonate; and for example, it is preferable to use the agent in a range of 1×10⁻⁴% by mass or more and 0.1% by mass or less with respect to the toner mother liquid.

The granulation of the toner mother liquid in the aqueous medium containing the inorganic dispersant is, for example, preferably carried under shearing. The toner mother liquid dispersed in the aqueous medium is granulated, for example, preferably to have an average particle diameter of 20 μm or less. In particular, the average particle diameter is, for example, preferably 3 μm or more and 15 μm or less.

As a device including the shearing mechanism, various dispersers can be used, and among the dispersers, for example, a homogenizer is preferable. By using a homogenizer, substances (in the present exemplary embodiment, the aqueous medium containing the inorganic dispersant and the toner mother liquid) incompatible with each other can be passed through a gap between a casing and a rotating rotor, and thus the substances incompatible with the liquid can be dispersed in the liquid in a particle shape. Examples of the homogenizer include a TK homomixer, a line flow homomixer, an auto homomixer (all of which are manufactured by TOKUSYU KIKA KOGYO KK); a SILVERSON homogenizer (manufactured by SILVERSON), and a POLYTRON homogenizer (manufactured by KINEMATICA (AG)).

A stirring condition for using the homogenizer is, for example, preferably 2 m/see or more in terms of circumferential speed of the blade of the rotor. In a case where the circumferential speed is less than the above-described value, the particle size is likely to be insufficient. In the present exemplary embodiment, the toner mother liquid is granulated in the aqueous medium containing the inorganic dispersant, and then the solvent is removed. The solvent may be removed at room temperature (25° C.) and normal pressure, but since it takes a long time to remove the solvent, it is preferable to remove the solvent under a temperature condition lower than a boiling point of the solvent and a range of a difference of 80° C. or lower from the boiling point. The pressure may be atmospheric pressure or reduced pressure, but in a case of reducing the pressure, for example, it is preferable to be at 20 mmHg or more and 150 mmHg or less.

In the present exemplary embodiment, it is preferable to wash the toner particles with hydrochloric acid or the like after the removal of the solvent. In this manner, the inorganic dispersant remaining on the surface of the toner particles is removed, and the original formulation of the toner particles is restored, whereby the characteristics are improved. Next, the toner particles in a form of powder can be obtained by carrying out dehydration and drying.

In the toner particles obtained by the dissolution suspension method, same as the coagulation method, in order to adjust charge, impart fluidity, impart charge exchange properties, and the like, inorganic oxides such as silica, titania, and aluminum oxide are added and attached as an external additive to the obtained toner particles. In addition to the above-described inorganic oxide and the like, other components (particles) such as a charge control agent, organic particles, a lubricant, and an abrasive may be added as the external additive.

In the present exemplary embodiment, in order to set the average value of the ratio b/a of the photoluminescent toner particles in the range of 0.5 or more and 0.8 or less, a method of adjusting the amount of the binder resin used for the metal pigment, the heating time during the fusion step in the coagulation method, and the like can be used. For example, by increasing the amount of the binder resin used for the metal pigment, it is easy to increase the average value of the ratio b/a of the toner particles. In addition, by increasing the heating time during the fusion step, it is easy to increase the average value of the ratio b/a of the toner particles.

In addition, for example, the ratio b/a is adjusted to a preferred range by the above-described stirring conditions in the aggregation step. More specifically, the ratio b/a can be reduced by stirring at a high speed and heating at a constant temperature in a stage of forming the aggregated particles, and the ratio b/a can be increased by stirring at a low speed and further heating.

Furthermore, for example, in order to adjust the ratio b/a to the preferred range, the toner particles may be treated with a ball mill.

In the present exemplary embodiment, in order to set the pigment area ratio in the range of 0.5 or more and 0.7 or less, a method of adjusting the average equivalent circle diameter of the metal pigment, the amount of the binder resin used for the metal pigment, the heating time during the fusion step in the coagulation method, and the like can be used. For example, the average equivalent circle diameter of the metal pigment is increased to increase the pigment area ratio. In addition, by increasing the amount of the binder resin used for the metal pigment, the pigment area ratio is easily reduced. In addition, by increasing the heating time during the fusion step, the pigment area ratio is easily increased.

### Electrostatic Charge Image Developer

The electrostatic charge image developer used in the present exemplary embodiment contains at least the toner according to the present exemplary embodiment.

The electrostatic charge image developer used in the present exemplary embodiment may be a one-component developer that contains only the toner according to the present exemplary embodiment or a two-component developer that is obtained by mixing the toner and a carrier together.

The carrier is not particularly limited, and examples thereof include known carriers. Examples of the carrier include a coated carrier obtained by coating the surface of a core material consisting of magnetic powder with a coating resin; a magnetic powder dispersion-type carrier obtained by dispersing magnetic powder in a matrix resin and mixing the powder and the resin together; and a resin impregnation-type carrier obtained by impregnating porous magnetic powder with a resin.

Each of the magnetic powder dispersion-type carrier and the resin impregnation-type carrier may be a carrier obtained by coating a core material, that are particles configuring the carrier, with a coating resin.

Examples of the magnetic powder include magnetic metals such as iron, nickel, and cobalt; and magnetic oxides such as ferrite and magnetite. In particular, for example, magnetite or ferrite is preferable. The magnetic powder can also be used as particles dispersed in a resin.

Examples of the coating resin and the matrix resin include polyethylene, polypropylene, polystyrene, polyvinyl acetate, polyvinyl alcohol, polyvinyl butyral, polyvinyl chloride, polyvinyl ether, polyvinyl ketone, a vinyl chloride-vinyl acetate copolymer, a styrene/acrylic acid ester copolymer, a straight silicone resin configured with an organosiloxane bond, a product obtained by modifying the straight silicone resin, a fluororesin, polyester, polycarbonate, a phenol resin, and an epoxy resin.

The coating resin and the matrix resin may contain other additives such as conductive particles.

Examples of the conductive particles include metals such as gold, silver, and copper, and particles such as carbon black, titanium oxide, zinc oxide, tin oxide, barium sulfate, aluminum borate, and potassium titanate.

The surface of the core material is coated with a coating resin, for example, by a coating method using a solution for forming a coating layer obtained by dissolving the coating resin and various additives, that are used as necessary, in an appropriate solvent, and the like. The solvent is not particularly limited, and may be selected in consideration of the type of the coating resin used, coating suitability, and the like.

Specifically, examples of the resin coating method include a dipping method of dipping the core material in the solution for forming a coating layer; a spray method of spraying the solution for forming a coating layer to the surface of the core material; a fluidized bed method of spraying the solution for forming a coating layer to the core material that is floating by an air flow; and a kneader coater method of mixing the core material of the carrier with the solution for forming a coating layer in a kneader coater and removing solvents.

The mixing ratio (mass ratio) between the toner and the carrier, represented by toner: carrier, in the two-component developer is, for example, preferably 1:100 to 30:100, and more preferably 3:100 to 20:100.

### Cleaning Blade

The cleaning blade used in the image forming apparatus according to the present exemplary embodiment will be described. The cleaning blade contains, for example, a resin (preferably, a polyurethane resin). The cleaning blade has a breaking energy of 5,000 MPa·% or more and 15,000 MPa·% or less, and a 100% modulus of 10 MPa or more at a contact portion with the image holder.

The cleaning blade may be a blade having a single-layered configuration consisting of one layer, may be a blade having a two-layered configuration consisting of a front surface layer (layer that is brought into contact with the image holder) and a back surface layer, or may be a configuration in which three or more layers are laminated.

### 100% Modulus (M100)

The 100% modulus of the cleaning blade at the surface (contact portion) in contact with the image holder is 10 MPa or more, and is, for example, preferably 12 MPa or more, and more preferably 14 MPa or more. In a case where the 100% modulus is 10 MPa or more, the breaking resistance of the cleaning blade is increased, and even in a case where the pressing force against the image holder is increased, the breaking is suppressed. In this manner, the pressing force against the surface of the image holder can be increased while suppressing chipping of the cleaning blade in a low-temperature and low-humidity environment. As a result, leakage of the toner particles associated with the occurrence of the chipping of the cleaning blade is suppressed, and the cleaning ability of the cleaning blade to the toner particles is improved. In addition, abrasion of the blade in a high-temperature and high-humidity environment is easily suppressed, and the occurrence of toner filming associated with the abrasion is easily suppressed. Therefore, occurrence of image defects is suppressed by suppressing the toner filming.

The 100% modulus of the cleaning blade at the contact portion is, for example, preferably 20 MPa or less, and more preferably 18 MPa or less. In a case where the 100% modulus is 20 MPa or less, a contact posture of the cleaning blade at the contact portion with the image holder is satisfactorily maintained, and the pressing force against the surface of the image holder is increased. As a result, the cleaning blade can improve the cleaning ability to the toner particles.

The 100% modulus of the cleaning blade at the contact portion with the image holder is 10 MPa or more, and is, for example, preferably 12 MPa or more and 20 MPa or less, and more preferably 14 MPa or more and 18 MPa or less.

The above-described 100% modulus is a value obtained from a stress at 100% strain, that is measured at 23° C. using a dumbbell-shaped No. 3 test piece in accordance with JIS K 6251 (2010) at a tensile speed of 500 mm/min. Strograph AE Elastomer (manufactured by Toyo Seiki-Seisaku-syo, Ltd.) is used as a measuring device. The test piece is collected from the surface (contact portion) of the cleaning blade in contact with the image holder.

Examples of a method of setting the above-described 100% modulus in the above-described range include a method of adjusting a formulation of a member (hereinafter, also referred to as “contact member”) of the cleaning blade in contact with the image holder. Specific examples thereof include a method of adjusting a content of a polyisocyanate component in a case where the contact member contains a polyurethane resin, a method of selecting at least one of the type or the amount of a crosslinking agent in a case where a crosslinking agent is used for manufacturing the contact member, and a combination thereof. As a weight-average molecular weight of the polyester polyol used for synthesizing the polyurethane resin contained in the contact member is larger, as the amount of the polyisocyanate component in the polyurethane resin is larger, or as a crosslinking density is higher, the 100% modulus is larger.

### Breaking Energy

The cleaning blade has a breaking energy of 5000 MPa % or more and 15000 MPa·% or less. The breaking energy is, for example, preferably 7000 MPa % or more and 12000 MPa·% or less, and more preferably 8000 MPa % or more and 10000 MPa % or less. In a case where the breaking energy is 5000 MPa % or more, the breaking resistance of the cleaning blade is increased, and even in a case where the pressing force against the image holder is increased, the breaking is suppressed. In this manner, the pressing force against the surface of the image holder can be increased while suppressing chipping of the cleaning blade in a low-temperature and low-humidity environment. As a result, leakage of the toner particles associated with the occurrence of the chipping of the cleaning blade is suppressed, and the cleaning ability of the cleaning blade to the toner particles is improved. In a case where the breaking energy is 15000 MPa·% or less, a contact posture of the cleaning blade at the contact portion with the image holder is satisfactorily maintained, and the pressing force against the surface of the image holder is increased. As a result, the cleaning blade can improve the cleaning ability to the toner particles.

The above-described breaking energy is obtained by performing the following measurement at 23° C. A sample of the cleaning blade cut out to have a width of 5 mm and a length of 25 mm is measured under a condition of a tensile speed of 20 mm/min using a load cell with a rated load of 5 kgf, using a tensile tester MODEL-1605N (manufactured by Aikoh Engineering Co., Ltd.). The test piece is collected from the surface (contact portion) of the cleaning blade in contact with the image holder.

Examples of a method of setting the above-described breaking energy in the above-described range include a method of adjusting a formulation of a member of the cleaning blade in contact with the image holder (that is, the contact member). Specifically, in a case where the contact member contains a polyurethane resin, as a weight-average molecular weight of the polyester polyol used for synthesizing the polyurethane resin is higher, the breaking energy is larger.

### Cleaning Blade Having Two-Layered Configuration

The cleaning blade may have a two-layered configuration of a front surface layer and a back surface layer. The cleaning blade having a front surface layer and a back surface layer (hereinafter, also simply referred to as “two-layered cleaning blade”) is produced, for example, by separately producing the front surface layer and the back surface layer by a method for producing a polyurethane resin described later, and bonding the obtained front surface layer and back surface layer to each other. In addition, the two-layered cleaning blade is produced by pouring a composition serving as a raw material for the back surface layer into a mold and curing the composition, and then pouring a composition serving as a raw material for the front surface layer into the remaining region of the mold and curing the composition.

In a case where physical properties of the front surface layer and the back surface layer are to be made different from each other, a method of changing a material of the polyurethane resin may be used.

In the front surface layer of the two-layered cleaning blade, the 100% modulus and the breaking energy at the contact portion with the image holder are within the above-described ranges.

Next, the back surface layer of the two-layered cleaning blade will be described.

100% modulus (M100) (of Back Surface Layer)

A 100% modulus of the back surface layer is, for example, preferably 3 MPa or more and 7 MPa or less, and more preferably 4 MPa or more and 6 MPa or less. In a case where the 100% modulus of the back surface layer is 3 MPa or more, stiffness of the cleaning blade is increased, and the pressing force against the image holder is increased. As a result, the cleaning blade can improve the cleaning ability to the toner particles. In a case where the 100% modulus of the back surface layer is 7 MPa or less, performance of blocking the toner particles and the like by the cleaning blade can be improved, and the cleaning ability to the toner particles can be improved.

The 100% modulus of the back surface layer is measured in the same manner as the method of measuring the 100% modulus described above. The dumbbell-shaped No. 3 test piece is collected from the back surface layer of the cleaning blade.

Examples of a method of setting the 100% modulus of the back surface layer in the above-described range include a method of adjusting a formulation of the back surface layer. Specific examples thereof include a method of adjusting a content of a polyisocyanate component in a case where the back surface layer contains a polyurethane resin, a method of selecting at least one of the type or the amount of a crosslinking agent in a case where a crosslinking agent is used for manufacturing the back surface layer, and a combination thereof. As a weight-average molecular weight of the polyester polyol used for synthesizing the polyurethane resin contained in the back surface layer is larger, as the amount of the polyisocyanate component in the polyurethane resin is larger, or as a crosslinking density is higher, the 100% modulus is larger.

### Permanent Elongation

A permanent elongation in the back surface layer is, for example, preferably less than 2.0%, and more preferably 1.0% or less. In a case where the permanent elongation is less than 2.0%, performance of blocking the toner particles and the like by the cleaning blade can be improved, and the cleaning ability to the toner particles can be improved.

The permanent elongation of the back surface layer is determined by applying 100% tensile strain to a strip-shaped test piece, leaving the test piece for 24 hours in accordance with JIS K 6262 (1997), and calculating a distance between marked lines according to the following expression. The test piece is collected from the back surface layer of the cleaning blade.

$$Ts = ( L 2 - L 0 ) / ( L 1 - L 0 )$$

In the above expression, Ts represents a permanent elongation, L0 represents a distance between the marked lines before the stretching, L1 represents a distance between the marked lines during the stretching, and L2 represents a distance between the marked lines after the stretching.

Examples of a method of setting the permanent elongation of the back surface layer in the above-described range include a method of adjusting a formulation of the back surface layer. Specific examples thereof include a method of adjusting a content of a polyisocyanate component in a case where the back surface layer contains a polyurethane resin, a method of selecting at least one of the type or the amount of a crosslinking agent in a case where a crosslinking agent is used for manufacturing the back surface layer, and a combination thereof. As a weight-average molecular weight of the polyester polyol used for synthesizing the polyurethane resin contained in the back surface layer is larger, as the amount of the polyisocyanate component in the polyurethane resin is larger, or as a crosslinking density is higher, the 100% modulus is larger.

A thickness of the cleaning blade is, for example, preferably 1.0 mm or more and 3.0 mm or less, and more preferably 1.5 mm or more and 2.5 mm or less.

In the cleaning blade having the two-layered configuration of a front surface layer and a back surface layer, a thickness of the front surface layer is, for example, preferably 0.2 mm or more and 1.0 mm or less, and more preferably 0.4 mm or more and 0.8 mm or less. In addition, a thickness of the back surface layer is, for example, preferably 0.6 mm or more and 2.6 mm or less, and more preferably 0.8 mm or more and 1.8 mm or less.

### Constitution

The cleaning blade contains a resin, for example, preferably contains a polyurethane resin. Here, a cleaning blade formed of a polyurethane resin will be described. In the cleaning blade having the two-layered configuration of a front surface layer and a back surface layer, for example, it is preferable that both the front surface layer and the back surface layer contains a resin (for example, preferably a polyurethane resin).

### Polyurethane Resin

The polyurethane resin is a polyurethane resin obtained by polymerizing at least a polyol component and a polyisocyanate component. In addition to the polyol component, the polyurethane resin may be, as necessary, a polyurethane resin obtained by polymerizing a resin having a functional group capable of reacting with an isocyanate group of polyisocyanate.

For example, the polyurethane resin preferably includes a hard segment and a soft segment. The term “hard segment” denotes a segment in which, among polyurethane resin materials, a material constituting the hard segment is relatively harder than a material constituting the soft segment; and the term “soft segment” denotes a segment in which, among polyurethane resin materials, a material constituting the soft segment is relatively softer than a material constituting the hard segment.

Examples of the material constituting the hard segment (hard segment material) include a low-molecular-weight polyol component as the polyol component, and the resin having a functional group capable of reacting with an isocyanate group of polyisocyanate. On the other hand, examples of the material constituting the soft segment (soft segment material) include a high-molecular-weight polyol component as the polyol component.

Here, an average particle diameter of aggregates of the hard segment is, for example, preferably 1 μm or more and 10 μm or less, and more preferably 1 μm or more and 5 μm or less.

In a case where the average particle diameter of the aggregates of the hard segment is 1 μm or more, frictional resistance of the surface of the contact member is likely to be reduced. Therefore, the behavior of the blade is stable, and local wear is likely to be suppressed.

On the other hand, in a case where the average particle diameter of the aggregates of the hard segment is 10 μm or less, the occurrence of chipping is likely to be suppressed.

The average particle diameter of the aggregates of the hard segment is measured as follows. By using a polarizing microscope (BX51-P manufactured by Olympus Corporation), an image is captured at a magnification of 20, and image processing is performed to convert the image into a binary image. For each of 20 cleaning blades, particle sizes (equivalent circle diameters) of aggregates are measured at 5 spots (at each spot, particle sizes of 5 aggregates are measured), and an average particle diameter of the 500 aggregates is calculated.

The binarization of the image is carried out by adjusting threshold values of hue, chroma, and brightness using image processing software OLYMPUS Stream essentials (manufactured by Olympus Corporation) such that the color of the aggregates in the crystal part and the hard segment is black and the color of the aggregates in the amorphous part (corresponding to the soft segment) is white.

### Polyol Component

The polyol component includes a high-molecular-weight polyol and a low-molecular-weight polyol.

The high-molecular-weight polyol component is a polyol having a number-average molecular weight of 500 or more (for example, preferably 500 or more and 5,000 or less). Examples of the high-molecular-weight polyol component include known polyols such as a polyester polyol obtained by dehydration condensation of a low-molecular-weight polyol and a dibasic acid, a polycarbonate polyol obtained by a reaction between a low-molecular-weight polyol and an alkyl carbonate, a polycaprolactone polyol, and a polyether polyol. Examples of a commercially available product of the high-molecular-weight polyol include PLACCEL 205 and PLACCEL 240 manufactured by Daicel Corporation.

Here, the number-average molecular weight is a value measured by a gel permeation chromatography (GPC) method. The same applies hereinafter.

These high-molecular-weight polyols may be used alone or in combination of two or more kinds thereof.

A polymerization ratio of the high-molecular-weight polyol component may be, for example, 30 mol % or more and 50 mol % or less, and preferably 40 mol % or more and 50 mol % or less with respect to the total polymerization component of the polyurethane resin.

The low-molecular-weight polyol component is a polyol having a molecular weight (number-average molecular weight) of less than 500. The low-molecular-weight polyol is a material that functions as a chain extender and a crosslinking agent.

Examples of the low-molecular-weight polyol component include 1,3-propanediol, 1,4-butanediol, 1,5-pentanediol, 1,6-hexanediol, 1,7-heptanediol, 1,8-octanediol, 1,9-nonanediol, 1,10-decanediol, 1,11-undecanediol, 1,12-dodecanediol, 1,13-tridecanediol, 1,14-tetradecanediol, 1,18-octadecanediol, and 1,20-eicosanediol. Among the above, 1,4-butanediol is used as the low-molecular-weight polyol component.

Examples of the low-molecular-weight polyol component include a diol (bifunctional), a triol (trifunctional), and a tetraol (tetrafunctional), that are known as a chain extender and a crosslinking agent.

These polyols may be used alone or in combination of two or more kinds thereof.

A polymerization ratio of the low-molecular-weight polyol component may be, for example, more than 50 mol % and 75 mol % or less, and preferably 52 mol % or more and 75 mol % or less, more preferably 55 mol % or more and 75 mol % or less, and still more preferably 55 mol % or more and 60 mol % or less with respect to the total polymerization component of the polyurethane resin.

In the cleaning blade, for example, it is preferable that a material constituting the contact portion with the image holder is a polyurethane in which a polyester polyol having a weight-average molecular weight of 1,000 or more and 10,000 or less, an isocyanate compound (that is, a polyisocyanate component), a crosslinking agent are polymerized. In addition, the weight-average molecular weight of the above-described polyester polyol is, for example, more preferably 2,000 or more and 8,000 or less. In a case of using the polyester polyol having a weight-average molecular weight in the above-described range, it is easy to control the 100% modulus at the contact portion and the breaking energy in the above-described ranges. The material constituting the contact portion with the image holder in the cleaning blade refers to, for example, a cleaning blade itself in a case where the cleaning blade is configured of only one layer, and refers to a front surface layer in contact with the image holder in a case where the cleaning blade has a two-layered configuration of a front surface layer and a back surface layer.

In a case where the cleaning blade has a two-layered configuration, for example, it is preferable that the back surface layer is a polyurethane in which a polyester polyol having a weight-average molecular weight of 100 or more and 2,000 or less, an isocyanate compound, a crosslinking agent are polymerized. In addition, the weight-average molecular weight of the above-described polyester polyol is, for example, more preferably 500 or more and 1000 or less. In a case of using the polyester polyol having a weight-average molecular weight in the above-described range, it is easy to control the 100% modulus at the back surface layer and the permanent elongation in the above-described ranges.

### Polyisocyanate Component

Examples of the polyisocyanate component include 4,4′-diphenylmethane diisocyanate (MDI), 2,6-toluene diisocyanate (TDI), 1,6-hexane diisocyanate (HDI), 1,5-naphthalene diisocyanate (NDI), and 3,3′-dimethylbiphenyl-4,4′-diisocyanate (TODI).

As the polyisocyanate component, for example, 4,4′-diphenylmethane diisocyanate (MDI), 1,5-naphthalene diisocyanate (NDI), or hexamethylene diisocyanate (HDI) is more desirable.

These polyisocyanate components may be used alone or in combination of two or more kinds thereof.

A polymerization ratio of the polyisocyanate component may be, for example, 5 mol % or more and 25 mol % or less, and preferably 10 mol % or more and 20 mol % or less with respect to the total polymerization component of the polyurethane resin.

In the cleaning blade, for example, it is preferable that a material constituting the contact portion with the image holder is a polyurethane in which a polyol, an isocyanate compound (that is, a polyisocyanate component), and a crosslinking agent are polymerized, and a proportion of the isocyanate compound in the material constituting the contact portion is 10 mol % or more and 40 mol % or less. In addition, the proportion of the above-described isocyanate compound in the above-described material constituting the contact portion is, for example, more preferably 15 mol % or more and 30 mol % or less. In a case where the proportion of the above-described isocyanate compound in the above-described material constituting the contact portion is within the above-described range, it is easy to control the 100% modulus at the contact portion and the breaking energy in the above-described ranges.

In a case where the cleaning blade has a two-layered configuration, for example, it is preferable that a material constituting the back surface layer is a polyurethane in which a polyol, an isocyanate compound (that is, a polyisocyanate component), and a crosslinking agent are polymerized, and a proportion of the isocyanate compound in the material constituting the back surface layer is 5 mol % or more and 20 mol % or less. In addition, the proportion of the above-described isocyanate compound in the above-described material constituting the back surface layer is, for example, more preferably 5 mol % or more and 15 mol % or less. In a case where the proportion of the above-described isocyanate compound in the above-described material constituting the back surface layer is within the above-described range, it is easy to control the 100% modulus at the back surface layer and the permanent elongation in the above-described ranges.

Resin Having Functional Group Capable of Reacting with Isocyanate Group

For example, it is desirable that the resin having a functional group capable of reacting with an isocyanate group (hereinafter, referred to as “functional group-containing resin”) is a flexible resin. From the viewpoint of flexibility, for example, an aliphatic resin having a linear structure is more desirable. Specific examples of the functional group-containing resin include an acrylic resin having two or more hydroxyl groups, a polybutadiene resin having two or more hydroxyl groups, and an epoxy resin having two or more epoxy groups.

Examples of a commercially available product of the acrylic resin having two or more hydroxyl groups include ACTFLOW (grades: UMB-2005B, UMB-2005P, UMB-2005, UME-2005, and the like) manufactured by Soken Chemical & Engineering Co., Ltd.

Examples of a commercially available product of the polybutadiene resin having two or more hydroxyl groups include R-45HT manufactured by Idemitsu Kosan Co., Ltd.

As the epoxy resin having two or more epoxy groups, for example, it is desirable to use an epoxy resin that is not hard and brittle just as the general epoxy resins of the related art and is more flexible and tougher than the epoxy resins of the related art. As the above-described epoxy resin, in view of molecular structure, for example, an epoxy resin that has a structure (flexible skeleton) capable of improving mobility of a main chain in a main chain structure thereof is suitable, and examples of the flexible skeleton include an alkylene skeleton, a cycloalkane skeleton, and a polyoxyalkylene skeleton. Among the above, for example, a polyoxyalkylene skeleton is particularly suitable.

In addition, in view of physical properties, compared to the epoxy resins of the related art, for example, an epoxy resin having a low viscosity relative to the molecular weight is suitable. Specifically, for example, it is desirable that a weight-average molecular weight is in a range of 900+100 and a viscosity at 25° C. is in a range of 15000+5000 mPa·s, more desirably in a range of 15000+3000 mPa·s. Examples of a commercially available product of the epoxy resin having the above-described characteristics include EPICLON EXA-4850-150 manufactured by DIC Corporation.

A polymerization ratio of the functional group-containing resin may be, for example, within a range not impairing the characteristics of the cleaning blade.

### Manufacturing Method of Polyurethane Resin

In manufacturing of the polyurethane resin, a general manufacturing method of polyurethane, such as a prepolymer method and a one-shot method, is used. From the viewpoint of obtaining polyurethane having excellent abrasion resistance and excellent chipping resistance, for excellent, a prepolymer method is suitable for the present exemplary embodiment, but the manufacturing method is not limited thereto.

The cleaning blade is produced by molding a composition for forming a cleaning blade, which is prepared by the above-described method, into a sheet by, for example, centrifugal molding, extrusion molding, or the like, and processing the sheet by cutting or the like.

Examples of a catalyst used for producing the polyurethane resin include an amine-based compound such as a tertiary amine, a quaternary ammonium salt, and an organometallic compound such as an organic tin compound.

Examples of the tertiary amine include trialkylamine such as triethylamine; tetraalkyl diamine such as N,N,N′,N′-tetramethyl-1,3-butanediamine; aminoalcohol such as dimethylethanolamine; esteramine such as ethoxylated amine, ethoxylated diamine, and bis(diethylethanolamine) adipate; a cyclohexylamine derivative such as triethylenediamine (TEDA) and N,N-dimethylcyclohexylamine; a morpholine derivative such as N-methylmorpholine and N-(2-hydroxypropyl)-dimethylmorpholine; and a piperazine derivative such as N,N′-diethyl-2-methylpiperazine and N,N′-bis-(2-hydroxypropyl)-2-methylpiperazine.

Examples of the quaternary ammonium salt include 2-hydroxypropyltrimethylammonium octylate, 1,5-diazabicyclo[4.3.0]nonene-5 (DBN) octylate, 1,8-diazabicyclo[5.4.0]undecene-7 (DBU)-octylate, DBU-oleate, DBU-p-toluenesulfonate, DBU-formate, and 2-hydroxypropyltrimethylammonium formate.

Examples of the organic tin compound include a dialkyltin compound such as dibutyltin dilaurate and dibutyltin di(2-ethylhexoate), stannous 2-ethylcaproate, and stannous oleate.

Among these catalysts, in view of hydrolysis resistance, triethylenediamine (TEDA) that is a tertiary ammonium salt is used, and in view of processability, a quaternary ammonium salt is used. Among the quaternary ammonium salts, 1,5-diazabicyclo[4.3.0]nonene-5 (DBN) octylate, 1,8-diazabicyclo[5.4.0]undecene-7 (DBU)-octylate, or DBU-formate, that has high reaction activity, is used.

A content of the catalyst is, for example, preferably in a range of 0.0005% by mass or more and 0.03% by mass or less and particularly preferably 0.001% by mass or more and 0.01% by mass or less of the entire polyurethane resin constituting the contact member.

The catalysts may be used alone or in combination of two or more kinds thereof.

In the cleaning blade, for example, it is preferable that a material constituting the contact portion with the image holder is a polyurethane in which a polyol, an isocyanate compound (that is, a polyisocyanate component), and a crosslinking agent are polymerized, and a crosslinking density is 0.90×10⁻³ mol/m³ or more and 1.50×10⁻³ mol/m³ or less. In addition, the above-described crosslinking density is, for example, more preferably 1.00×10⁻³ mol/m³ or more and 1.30×10⁻³ mol/m³ or less. In a case where the crosslinking density is within the above-described range, it is easy to control the 100% modulus at the contact portion and the breaking energy in the above-described ranges.

In a case where the cleaning blade has a two-layered configuration, for example, it is preferable that a material constituting the back surface layer is a polyurethane in which a polyol, an isocyanate compound (that is, a polyisocyanate component), and a crosslinking agent are polymerized, and a crosslinking density is 1.5×10⁻³ mol/m³ or more and 2.5×10⁻³ mol/m³ or less. In addition, the above-described crosslinking density is, for example, more preferably 1.8×10⁻³ mol/m³ or more and 2.2×10⁻³ mol/m³ or less. In a case where the crosslinking density is within the above-described range, it is easy to control the 100% modulus at the back surface layer and the permanent elongation in the above-described ranges.

### Image Holder

The image holder used in the image forming apparatus according to the present exemplary embodiment will be described. In the present exemplary embodiment, an electrophotographic photoreceptor (hereinafter, also referred to as “photoreceptor”) is used as the image holder on which the toner image is formed on the surface.

Examples of the photoreceptor include a photoreceptor configured to include a conductive substrate and a photosensitive layer provided on the conductive substrate.

Hereinafter, the electrophotographic photoreceptor will be described with reference to the accompanying drawing.

Examples of an electrophotographic photoreceptor 7 shown in FIG. 2 include a photoreceptor 7 having a structure in which an undercoat layer 1, a charge generation layer 2, and a charge transport layer 3 are laminated in this order on a conductive support 4. The charge generation layer 2 and the charge transport layer 3 constitute a photosensitive layer 5.

The electrophotographic photoreceptor 7 may have a layer configuration in which the undercoat layer 1 is not provided.

In addition, the electrophotographic photoreceptor 7 may be a photoreceptor having a single layer-type photosensitive layer in which functions of the charge generation layer 2 and the charge transport layer 3 are integrated. In a case of the photoreceptor having a single layer-type photosensitive layer, the single layer-type photosensitive layer constitutes the outermost surface layer.

In addition, the electrophotographic photoreceptor 7 may be a photoreceptor having a surface protective layer on the charge transport layer 3 or on the single layer-type photosensitive layer. In a case of a photoreceptor having a surface protective layer, the surface protective layer constitutes the outermost surface layer.

Hereinafter, each layer of the electrophotographic photoreceptor will be described in detail. The reference numerals will not be provided.

### Conductive Substrate

Examples of the conductive substrate include metal plates, metal drums, metal belts, or the like, containing a metal (such as aluminum, copper, zinc, chromium, nickel, molybdenum, vanadium, indium, gold, and platinum) or an alloy (such as stainless steel). In addition, examples of the conductive substrate also include paper, a resin film, a belt, or the like, that is obtained by being coated, vapor—deposited, or laminated with a conductive compound (such as a conductive polymer and indium oxide), a metal (such as aluminum, palladium, and gold) or an alloy. Here, the term “conductive” denotes that a volume resistivity is less than 10¹³Ω·cm.

In a case where the electrophotographic photoreceptor is used in a laser printer, for example, it is preferable that a surface of the conductive substrate is roughened such that a centerline average roughness Ra thereof is 0.04 μm or more and 0.5 μm or less for the purpose of suppressing interference fringes from occurring in a case of irradiation with laser beams. In a case where incoherent light is used as a light source, roughening of the surface to prevent the interference fringes is not particularly necessary, and it is appropriate for longer life because occurrence of defects due to the roughness of the surface of the conductive substrate is suppressed.

Examples of the roughening method include wet honing performed by suspending an abrasive in water and spraying the suspension to the conductive substrate, centerless grinding performed by pressure-welding the conductive substrate against a rotating grindstone and continuously grinding the conductive substrate, and an anodizing treatment.

Examples of the roughening method also include a method of dispersing conductive or semi-conductive powder in a resin without roughening the surface of the conductive substrate to form a layer on the surface of the conductive substrate, and performing roughening using the particles dispersed in the layer.

The roughening treatment by anodization is a treatment of forming an oxide film on the surface of the conductive substrate by carrying out anodization in an electrolytic solution using a conductive substrate made of a metal (for example, aluminum) as an anode. Examples of the electrolytic solution include a sulfuric acid solution and an oxalic acid solution. However, a porous anodized film formed by the anodization is chemically active in a natural state, is easily contaminated, and has a large resistance fluctuation depending on the environment. Therefore, for example, it is preferable that a sealing treatment is performed on the porous anodized film so that micropores of the oxide film are closed by volume expansion due to a hydration reaction in pressurized steam or boiling water (a metal salt such as nickel may be added thereto) for a change into a more stable a hydrous oxide.

A film thickness of the anodized film is, for example, preferably 0.3 μm or more and 15 μm or less. In a case where the film thickness is within the above-described range, barrier properties against injection tend to be exhibited, and an increase in the residual potential due to repeated use tends to be suppressed.

The conductive substrate may be subjected to a treatment with an acidic treatment liquid or a boehmite treatment.

The treatment with an acidic treatment liquid is carried out, for example, as follows. First, an acidic treatment liquid containing phosphoric acid, chromic acid, and hydrofluoric acid is prepared. As a blending proportion of the phosphoric acid, chromic acid, and hydrofluoric acid to the acidic treatment liquid, for example, a concentration of the phosphoric acid may be in a range of 10% by mass or more and 11% by mass or less, a concentration of the chromic acid may be in a range of 3% by mass or more and 5% by mass or less, and a concentration of the hydrofluoric acid may be in a range of 0.5% by mass or more and 2% by mass or less, and a concentration of all of these acids may be in a range of 13.5% by mass or more and 18% by mass or less. A treatment temperature is, for example, preferably 42° C. or higher and 48° C. or lower. A film thickness of the coating film is, for example, preferably 0.3 μm or more and 15 μm or less.

The boehmite treatment is carried out, for example, by dipping the base material in pure water at 90° C. or higher and 100° C. or lower for 5 minutes to 60 minutes, or by bringing the base material into contact with heated steam at 90° C. or higher and 120° C. or lower for 5 minutes to 60 minutes. A film thickness of the coating film is, for example, preferably 0.1 μm or more and 5 μm or less. The coating film may be further subjected to an anodizing treatment using an electrolytic solution having low film solubility, such as adipic acid, boric acid, a borate, a phosphate, a phthalate, a maleate, a benzoate, a tartrate, or a citrate.

### Undercoat Layer

The undercoat layer is, for example, a layer containing inorganic particles and a binder resin.

Examples of the inorganic particles include inorganic particles having a powder resistance (volume resistivity) of 10²Ω·cm or more and 10¹¹Ω·cm or less.

Among the above, as the inorganic particles having the above-described resistance value, for example, metal oxide particles such as tin oxide particles, titanium oxide particles, zinc oxide particles, and zirconium oxide particles may be used, and zinc oxide particles are particularly preferable.

A specific surface area of the inorganic particles, measured by a BET method, may be, for example, 10 m²/g or more.

A volume-average particle diameter of the inorganic particles may be 50 nm or more and 2,000 nm or less (for example, preferably 60 nm or more and 1,000 nm or less).

A content of the inorganic particles is, for example, preferably 10% by mass or more and 80% by mass or less, and more preferably 40% by mass or more and 80% by mass or less with respect to the binder resin.

The inorganic particles may be subjected to a surface treatment. As the inorganic particles, two or more kinds of inorganic particles subjected to different surface treatments or two or more kinds of inorganic particles having different particle diameters may be used in a form of a mixture.

Examples of a surface treatment agent include a silane coupling agent, a titanate-based coupling agent, an aluminum-based coupling agent, and a surfactant. In particular, for example, a silane coupling agent is preferable, and a silane coupling agent having an amino group is more preferable.

Examples of the silane coupling agent having an amino group include 3-aminopropyltriethoxysilane, N-2-(aminoethyl)-3-aminopropyltrimethoxysilane, N-2-(aminoethyl)-3-aminopropylmethyldimethoxysilane, and N,N-bis(2-hydroxyethyl)-3-aminopropyltriethoxysilane; but the present invention is not limited thereto.

The silane coupling agent may be used in a form of a mixture of two or more kinds thereof. For example, the silane coupling agent having an amino group and other silane coupling agents may be used in combination. Examples of the other silane coupling agents include vinyltrimethoxysilane, 3-methacryloxypropyl-tris(2-methoxyethoxy) silane, 2-(3,4-epoxycyclohexyl)ethyltrimethoxysilane, 3-glycidoxypropyltrimethoxysilane, vinyltriacetoxysilane, 3-mercaptopropyltrimethoxysilane, 3-aminopropyltriethoxysilane, N-2-(aminoethyl)-3-aminopropyltrimethoxysilane, N-2-(aminoethyl)-3-aminopropylmethyldimethoxysilane, N,N-bis(2-hydroxyethyl)-3-aminopropyltriethoxysilane, and 3-chloropropyltrimethoxysilane; but the present invention is not limited thereto.

A surface treatment method using the surface treatment agent may be any method as long as the method is a known method, and any of a dry method or a wet method may be used.

A treatment amount of the surface treatment agent is, for example, preferably 0.5% by mass or more and 10% by mass or less with respect to the inorganic particles.

Here, for example, the undercoat layer may contain an electron-accepting compound (acceptor compound) together with the inorganic particles from the viewpoint of enhancing long-term stability of electrical properties and carrier blocking properties.

Examples of the electron-accepting compound include electron-transporting substances, for example, a compound having an anthraquinone structure; a quinone-based compound such as chloranil and bromanil; a tetracyanoquinodimethane-based compound; a fluorenone compound such as 2,4,7-trinitrofluorenone and 2,4,5,7-tetranitro-9-fluorenone; an oxadiazole-based compound such as 2-(4-biphenyl)-5-(4-t-butylphenyl)-1,3,4-oxadiazole, 2,5-bis(4-naphthyl)-1,3,4-oxadiazole, and 2,5-bis(4-diethylaminophenyl)-1,3,4-oxadiazole; a xanthone-based compound; a thiophene compound; a diphenoquinone compound such as 3,3′,5,5′-tetra-t-butyldiphenoquinone; and a benzophenone compound.

In particular, as the electron-accepting compound, for example, a compound having an anthraquinone structure is preferable. As the compound having an anthraquinone structure, for example, a hydroxyanthraquinone compound, an aminoanthraquinone compound, or an aminohydroxyanthraquinone compound is preferable; and specifically, anthraquinone, alizarin, quinizarin, anthrarufin, purpurin, or a derivative thereof is preferable.

The electron-accepting compound may be contained in the undercoat layer in a state of being dispersed with the inorganic particles, or in a state of being attached to the surface of the inorganic particles.

Examples of a method of attaching the electron-accepting compound to the surface of the inorganic particles include a dry method and a wet method.

The dry method is, for example, a method of attaching the electron-accepting compound to the surface of the inorganic particles by adding the electron-accepting compound dropwise to the inorganic particles directly or by dissolving the electron-accepting compound in an organic solvent while agitating the inorganic particles with a mixer having a large shearing force and spraying the mixture together with dry air or nitrogen gas. For example, the dropwise addition or spraying of the electron-accepting compound may be performed at a temperature equal to or lower than a boiling point of the solvent. After the dropwise addition or spraying of the electron-accepting compound, the mixture may be further baked at 100° C. or higher. The baking is not particularly limited as long as the temperature and the time are adjusted such that electrophotographic characteristics can be obtained.

The wet method is, for example, a method of attaching the electron-accepting compound to the surface of the inorganic particles by adding the electron-accepting compound to inorganic particles while dispersing the inorganic particles in a solvent by performing agitating or using ultrasonic waves, a sand mill, an attritor, or a ball mill, agitating or dispersing the mixture, and removing the solvent. The solvent removing method is carried out by, for example, filtration or distillation so that the solvent is distilled off. After removal of the solvent, the mixture may be further baked at 100° C. or higher. The baking is not particularly limited as long as the temperature and the time are adjusted such that electrophotographic characteristics can be obtained. In the wet method, the moisture contained in the inorganic particles may be removed before the electron-accepting compound is added, and examples thereof include a method of removing the moisture while agitating and heating the inorganic particles in a solvent and a method of removing the moisture by azeotropically boiling the inorganic particles with a solvent.

The electron-accepting compound may be attached before or after the inorganic particles are subjected to the surface treatment with the surface treatment agent or simultaneously with the surface treatment with the surface treatment agent.

A content of the electron-accepting compound may be, for example, 0.01% by mass or more and 20% by mass or less, preferably 0.01% by mass or more and 10% by mass or less with respect to the inorganic particles.

Examples of the binder resin used for the undercoat layer include a known polymer compound such as an acetal resin (such as polyvinyl butyral), a polyvinyl alcohol resin, a polyvinyl acetal resin, a casein resin, a polyamide resin, a cellulose resin, gelatin, a polyurethane resin, a polyester resin, an unsaturated polyester resin, a methacrylic resin, an acrylic resin, a polyvinyl chloride resin, a polyvinyl acetate resin, a vinyl chloride-vinyl acetate-maleic anhydride resin, a silicone resin, a silicone-alkyd resin, a urea resin, a phenol resin, a phenol-formaldehyde resin, a melamine resin, a urethane resin, an alkyd resin, and an epoxy resin; a zirconium chelate compound; a titanium chelate compound; an aluminum chelate compound; a titanium alkoxide compound; an organic titanium compound; and a known material such as a silane coupling agent.

Examples of the binder resin used for the undercoat layer also include a charge-transporting resin having a charge-transporting group, and a conductive resin (for example, polyaniline or the like).

Among the above, as the binder resin used for the undercoat layer, for example, a resin insoluble in a coating solvent of an upper layer is suitable; and a resin obtained by a reaction between at least one resin selected from the group consisting of a thermosetting resin such as a urea resin, a phenol resin, a phenol-formaldehyde resin, a melamine resin, a urethane resin, an unsaturated polyester resin, an alkyd resin, or an epoxy resin; a polyamide resin, a polyester resin, a polyether resin, a methacrylic resin, an acrylic resin, a polyvinyl alcohol resin, and a polyvinyl acetal resin, and a curing agent is particularly suitable.

In a case where these binder resins are used in combination of two or more kinds thereof, a mixing proportion thereof is set as necessary.

The undercoat layer may contain various additives for improving the electrical properties, the environmental stability, and the image quality.

Examples of the additive include known materials, for example, an electron-transporting pigment such as a polycyclic condensed pigment or an azo-based pigment, a zirconium chelate compound, a titanium chelate compound, an aluminum chelate compound, a titanium alkoxide compound, an organic titanium compound, and a silane coupling agent. The silane coupling agent is used for the surface treatment of the inorganic particles as described above, but may be further added to the undercoat layer as the additive.

Examples of the silane coupling agent as the additive include vinyltrimethoxysilane, 3-methacryloxypropyl-tris(2-methoxyethoxy) silane, 2-(3,4-epoxycyclohexyl)ethyltrimethoxysilane, 3-glycidoxypropyltrimethoxysilane, vinyltriacetoxysilane, 3-mercaptopropyltrimethoxysilane, 3-aminopropyltriethoxysilane, N-2-(aminoethyl)-3-aminopropyltrimethoxysilane, N-2-(aminoethyl)-3-aminopropylmethyldimethoxysilane, N,N-bis(2-hydroxyethyl)-3-aminopropyltriethoxysilane, and 3-chloropropyltrimethoxysilane.

Examples of the zirconium chelate compound include zirconium butoxide, ethyl zirconium acetoacetate, zirconium triethanolamine, acetylacetonate zirconium butoxide, ethyl zirconium butoxide acetoacetate, zirconium acetate, zirconium oxalate, zirconium lactate, zirconium phosphonate, zirconium octanoate, zirconium naphthenate, zirconium laurate, zirconium stearate, zirconium isostearate, zirconium butoxide methacrylate, stearate zirconium butoxide, and isostearate zirconium butoxide.

Examples of the titanium chelate compound include tetraisopropyl titanate, tetranormal butyl titanate, a butyl titanate dimer, tetra(2-ethylhexyl) titanate, titanium acetylacetonate, polytitanium acetylacetonate, titanium octylene glycolate, titanium lactate ammonium salt, titanium lactate, titanium lactate ethyl ester, titanium triethanol aminate, and polyhydroxy titanium stearate.

Examples of the aluminum chelate compound include aluminum isopropylate, monobutoxyaluminum diisopropylate, aluminum butyrate, diethylacetoacetate aluminum diisopropylate, and aluminum tris(ethylacetoacetate).

These additives may be used alone or in a form of a mixture or a polycondensate of a plurality of compounds.

The undercoat layer may have, for example, a Vickers hardness of 35 or more.

For example, the surface roughness (ten-point average roughness) of the undercoat layer may be adjusted to 1/2 from 1/(4n) (n represents a refractive index of an upper layer) of a laser wavelength 2 for exposure to be used to suppress moire fringes.

Resin particles or the like may be added to the undercoat layer to adjust the surface roughness. Examples of the resin particles include silicone resin particles and crosslinked polymethyl methacrylate resin particles. In addition, the surface of the undercoat layer may be polished to adjust the surface roughness. Examples of a polishing method include buff polishing, a sandblast treatment, wet honing, and a grinding treatment.

The formation of the undercoat layer is not particularly limited, and a known forming method is used. For example, a coating film of a coating solution for forming the undercoat layer, in which the above-described components are added to a solvent, is formed, and the coating film is dried and then heated as necessary.

Examples of the solvent for preparing the coating solution for forming the undercoat layer include known organic solvents such as an alcohol-based solvent, an aromatic hydrocarbon solvent, a halogenated hydrocarbon solvent, a ketone-based solvent, a ketone alcohol-based solvent, an ether-based solvent, and an ester-based solvent.

Specific examples of the solvent include typical organic solvents such as methanol, ethanol, n-propanol, iso-propanol, n-butanol, benzyl alcohol, methyl cellosolve, ethyl cellosolve, acetone, methyl ethyl ketone, cyclohexanone, methyl acetate, ethyl acetate, n-butyl acetate, dioxane, tetrahydrofuran, methylene chloride, chloroform, chlorobenzene, and toluene.

Examples of the method of dispersing the inorganic particles in a case of preparing the coating solution for forming the undercoat layer include known methods such as a roll mill, a ball mill, a vibration ball mill, an attritor, a sand mill, a colloid mill, and a paint shaker.

Examples of the method of coating the conductive substrate with the coating solution for forming the undercoat layer include typical coating methods such as a blade coating method, a wire bar coating method, a spray coating method, a dip coating method, a bead coating method, an air knife coating method, and a curtain coating method.

A film thickness of the undercoat layer is set to, for example, preferably 15 μm or more and more preferably in a range of 20 μm or more and 50 μm or less.

### Interlayer

Although not shown in the drawings, an interlayer may be further provided between the undercoat layer and the photosensitive layer.

The interlayer is, for example, a layer containing a resin. Examples of the resin used for the interlayer include polymer compounds such as an acetal resin (for example, polyvinyl butyral or the like), a polyvinyl alcohol resin, a polyvinyl acetal resin, a casein resin, a polyamide resin, a cellulose resin, gelatin, a polyurethane resin, a polyester resin, a methacrylic resin, an acrylic resin, a polyvinyl chloride resin, a polyvinyl acetate resin, a vinyl chloride-vinyl acetate-maleic anhydride resin, a silicone resin, a silicone-alkyd resin, a phenol-formaldehyde resin, and a melamine resin.

The interlayer may be a layer containing an organometallic compound. Examples of the organometallic compound used for the interlayer include organometallic compounds containing a metal atom such as zirconium, titanium, aluminum, manganese, and silicon.

The compounds used for the interlayer may be used alone or in a form of a mixture or a polycondensate of a plurality of compounds.

Among the above, for example, it is preferable that the interlayer is a layer containing an organometallic compound containing a zirconium atom or a silicon atom.

The formation of the interlayer is not particularly limited, and a known forming method is used. For example, a coating film of a coating solution for forming the interlayer, in which the above-described components are added to a solvent, is formed, and the coating film is dried and then heated as necessary.

Examples of the coating method of forming the interlayer include typical methods such as a dip coating method, a push-up coating method, a wire bar coating method, a spray coating method, a blade coating method, an air knife coating method, and a curtain coating method.

A film thickness of the interlayer is set to, for example, preferably in a range of 0.1 μm or more and 3 μm or less. The interlayer may be used as the undercoat layer.

### Charge Generation Layer

A charge generation layer is, for example, a layer containing a charge generation material and a binder resin. In addition, the charge generation layer may be a deposition layer of the charge generation material. For example, the deposition layer of the charge generation material is suitable in a case where an incoherent light source such as a light emitting diode (LED) and an organic electro-luminescence (EL) image array is used.

Examples of the charge generation material include an azo pigment such as a bisazo pigment and a trisazo pigment; a fused ring aromatic pigment such as dibromoanthanthrone; a perylene pigment; a pyrrolopyrrole pigment; a phthalocyanine pigment; zinc oxide; and trigonal selenium.

Among the above, for example, a metal phthalocyanine pigment or a metal-free phthalocyanine pigment is preferably used as the charge generation material, in order to deal with laser exposure in a near-infrared region. Specifically, for example, hydroxy gallium phthalocyanine, chlorogallium phthalocyanine, dichlorotin phthalocyanine, or titanyl phthalocyanine is more preferable.

On the other hand, for example, a fused ring aromatic pigment such as dibromoanthanthrone; a thioindigo-based pigment; a porphyrazine compound; zinc oxide; trigonal selenium; or a bisazo pigment is preferable as the charge generation material in order to deal with laser exposure in a near-ultraviolet region.

The above-described charge generation material may be used even in a case where a non-coherent light source such as an LED having a central wavelength of light emission in a range of 450 nm or more and 780 nm or less and an organic EL image array is used.

On the other hand, in a case where an n-type semiconductor such as a fused ring aromatic pigment, a perylene pigment, and an azo pigment is used as the charge generation material, a dark current is unlikely to be generated, and image defects referred to as black spots can be suppressed even in a case in which a thin film is used as the photosensitive layer.

The n-type is determined by the polarity of the flowing photocurrent using a typically used time-of-flight method, and a material in which electrons more easily flow as carriers than positive holes is determined as the n-type.

The binder resin used for the charge generation layer is selected from a wide range of insulating resins, and the binder resin may be selected from organic photoconductive polymers such as poly-N-vinylcarbazole, polyvinylanthracene, polyvinylpyrene, and polysilane.

Examples of the binder resin include a polyvinyl butyral resin, a polyarylate resin (polycondensate of bisphenols and aromatic divalent carboxylic acid, or the like), a polycarbonate resin, a polyester resin, a phenoxy resin, a vinyl chloride-vinyl acetate copolymer, a polyamide resin, an acrylic resin, a polyacrylamide resin, a polyvinylpyridine resin, a cellulose resin, a urethane resin, an epoxy resin, casein, a polyvinyl alcohol resin, and a polyvinylpyrrolidone resin. Here, the term “insulating” means that a volume resistivity is 10¹³Ω·cm or more.

The binder resins may be used alone or in a form of a mixture of two or more kinds thereof.

A blending ratio between the charge generation material and the binder resin is, for example, preferably in a range of 10:1 to 1:10 in terms of mass ratio.

The charge generation layer may also contain other known additives.

The formation of the charge generation layer is not particularly limited, and a known forming method is used. For example, a coating film of a coating solution for forming the charge generation layer, in which the above-described components are added to a solvent, is formed, and the coating film is dried and then heated as necessary. The charge generation layer may be formed by a vapor deposition of the charge generation material. For example, the formation of the charge generation layer by the vapor deposition is particularly preferable in a case where the fused ring aromatic pigment or the perylene pigment is used as the charge generation material.

Examples of the solvent for preparing the coating solution for forming the charge generation layer include methanol, ethanol, n-propanol, n-butanol, benzyl alcohol, methyl cellosolve, ethyl cellosolve, acetone, methyl ethyl ketone, cyclohexanone, methyl acetate, n-butyl acetate, dioxane, tetrahydrofuran, methylene chloride, chloroform, chlorobenzene, and toluene. The solvents are used alone or in a form of a mixture of two or more kinds thereof.

As a method of dispersing particles (for example, the charge generation material) in the coating solution for forming the charge generation layer, for example, a media disperser such as a ball mill, a vibration ball mill, an attritor, a sand mill, and a horizontal sand mill, or a medialess disperser such as an agitator, an ultrasonic disperser, a roll mill, and a high-pressure homogenizer is used. Examples of the high-pressure homogenizer include a collision type high-pressure homogenizer in which a dispersion liquid is dispersed by a liquid-liquid collision or a liquid-wall collision in a high-pressure state, and a penetration type high-pressure homogenizer in which a dispersion liquid is dispersed by causing the dispersion liquid to penetrate through a micro-flow path in a high-pressure state.

During the dispersion, it is effective to set an average particle diameter of the charge generation material in the coating solution for forming the charge generation layer to 0.5 μm or less, for example, preferably 0.3 μm or less and more preferably 0.15 μm or less.

Examples of the method of coating the undercoat layer (or the interlayer) with the coating solution for forming the charge generation layer include typical methods such as a blade coating method, a wire bar coating method, a spray coating method, a dip coating method, a bead coating method, an air knife coating method, and a curtain coating method.

A film thickness of the charge generation layer is set to, for example, preferably in a range of 0.1 μm or more and 5.0 μm or less and more preferably in a range of 0.2 μm or more and 2.0 μm or less.

### Charge Transport Layer

A charge transport layer is, for example, a layer containing a charge transport material and a binder resin. The charge transport layer may be a layer containing a polymer charge transport material.

Examples of the charge transport material include a quinone-based compound such as p-benzoquinone, chloranil, bromanil, and anthraquinone; a tetracyanoquinodimethane-based compound; a fluorenone compound such as 2,4,7-trinitrofluorenone; a xanthone-based compound; a benzophenone-based compound; a cyanovinyl-based compound; and an electron-transporting compound such as an ethylene-based compound. Examples of the charge transport material also include a positive hole-transporting compound such as a triarylamine-based compound, a benzidine-based compound, an arylalkane-based compound, an aryl-substituted ethylene-based compound, a stilbene-based compound, an anthracene-based compound, and a hydrazone-based compound. The charge transport materials may be used alone or in combination of two or more kinds thereof, but are not limited thereto.

From the viewpoint of charge mobility, for example, a triarylamine derivative represented by Structural Formula (a-1) or a benzidine derivative represented by Structural Formula (a-2) is preferable as the charge transport material.

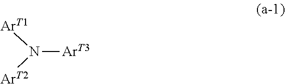

In Structural Formula (a-1), Ar^{T1}, Ar^{T2}, and Ar^{T3} each independently represent a substituted or unsubstituted aryl group, —C₆H₄—C(R^{T4})═C(R^{T5})(R^{T6}), or —C₆H₄—CH═CH—CH═C(R^{T7})(R^{T8}). R^{T4}, R^{T5}, R^{T6}, R^{T7}, and R^{T8} each independently represent a hydrogen atom, a substituted or unsubstituted alkyl group, or a substituted or unsubstituted aryl group.

Examples of the substituent of each group described above include a halogen atom, an alkyl group having 1 or more and 5 or less carbon atoms, and an alkoxy group having 1 or more and 5 or less carbon atoms. In addition, examples of the substituent of each group described above also include a substituted amino group substituted with an alkyl group having 1 or more and 3 or less carbon atoms.

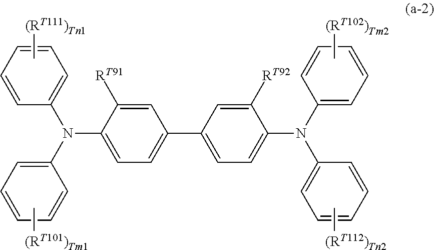

In Structural Formula (a-2), R^{T91} and R^{T92} each independently represent a hydrogen atom, a halogen atom, an alkyl group having 1 or more and 5 or less carbon atoms, or an alkoxy group having 1 or more and 5 or less carbon atoms. R^{T101}, R^{T102}, R^{T111}, and R^{T112} each independently represent a halogen atom, an alkyl group having 1 or more and 5 or less carbon atoms, an alkoxy group having 1 or more and 5 or less carbon atoms, an amino group substituted with an alkyl group having 1 or more and 2 or less carbon atoms, a substituted or unsubstituted aryl group, —C(R^{T12})═C(R^{T13})(R^{T14}), or —CH═CH—CH═C(R^{T15})(R^{T16}), in which R^{T12}, R^{T13}, R^{T14}, R^{T15}, and R^{T16} each independently represent a hydrogen atom, a substituted or unsubstituted alkyl group, or a substituted or unsubstituted aryl group. Tm1, Tm2, Tn1, and Tn2 each independently represent an integer of 0 or more and 2 or less.

Examples of the substituent of each group described above include a halogen atom, an alkyl group having 1 or more and 5 or less carbon atoms, and an alkoxy group having 1 or more and 5 or less carbon atoms. In addition, examples of the substituent of each group described above also include a substituted amino group substituted with an alkyl group having 1 or more and 3 or less carbon atoms.

Here, among the triarylamine derivative represented by Structural Formula (a-1) and the benzidine derivative represented by Structural Formula (a-2), for example, a triarylamine derivative having “—C₆H₄—CH═CH—CH═C(R^{T7})(R^{T8})” or a benzidine derivative having “—CH═CH—CH═C(R^{T15})(R^{T16})” is particularly preferable from the viewpoint of the charge mobility.

As the polymer charge transport material, known materials having charge transport properties, such as poly-N-vinylcarbazole and polysilane, are used. In particular, for example, a polyester-based polymer charge transport material is particularly preferable. The polymer charge transport material may be used alone or in combination of the binder resin.

Examples of the binder resin used for the charge transport layer include a polycarbonate resin, a polyester resin, a polyarylate resin, a methacrylic resin, an acrylic resin, a polyvinyl chloride resin, a polyvinylidene chloride resin, a polystyrene resin, a polyvinyl acetate resin, a styrene-butadiene copolymer, a vinylidene chloride-acrylonitrile copolymer, a vinyl chloride-vinyl acetate copolymer, a vinyl chloride-vinyl acetate-maleic anhydride copolymer, a silicone resin, a silicone alkyd resin, a phenol-formaldehyde resin, a styrene-alkyd resin, poly-N-vinylcarbazole, and polysilane. Among the above, for example, a polycarbonate resin or a polyarylate resin is preferable as the binder resin. The binder resins may be used alone or in combination of two or more kinds thereof.

A blending ratio between the charge transport material and the binder resin is, for example, preferably 10:1 to 1:5 in terms of mass ratio.

The charge transport layer may also contain other known additives.

The formation of the charge transport layer is not particularly limited, and a known forming method is used. For example, a coating film of a coating solution for forming the charge transport layer, in which the above-described components are added to a solvent, is formed, and the coating film is dried and then heated as necessary.

Examples of the solvent for preparing the coating solution for forming the charge transport layer include typical organic solvents, for example, aromatic hydrocarbons such as benzene, toluene, xylene, and chlorobenzene; ketones such as acetone and 2-butanone; halogenated aliphatic hydrocarbons such as methylene chloride, chloroform, and ethylene chloride; and cyclic or linear ethers such as tetrahydrofuran and ethyl ether. The solvents are used alone or in a form of a mixture of two or more kinds thereof.

Examples of the coating method of coating the charge generation layer with the coating solution for forming the charge transport layer include typical methods such as a blade coating method, a wire bar coating method, a spray coating method, a dip coating method, a bead coating method, an air knife coating method, and a curtain coating method.

A film thickness of the charge transport layer is set to, for example, preferably in a range of 5 μm or more and 50 μm or less and more preferably in a range of 10 μm or more and 30 μm or less.

### Protective Layer

A protective layer is provided on the photosensitive layer as necessary. The protective layer is provided, for example, for the purpose of preventing a chemical change in the photosensitive layer during charging and further improving a mechanical strength of the photosensitive layer.

Therefore, for example, a layer formed of a cured film (crosslinked film) may be applied to the protective layer. Examples of the layer include layers described in the items 1) and 2) below.

1) A layer formed of a cured film with a composition containing a reactive group-containing charge transport material that has a reactive group and a charge-transporting skeleton in the same molecule (that is, a layer containing a polymer or a crosslinked body of the reactive group-containing charge transport material)

2) A layer formed of a cured film with a composition containing a non-reactive charge transport material and a reactive group-containing non-charge transport material that has a reactive group and does not have a charge-transporting skeleton (that is, a layer containing the non-reactive charge transport material, and a polymer or a crosslinked body of the reactive group-containing non-charge transport material)

Examples of the reactive group of the reactive group-containing charge transport material include known reactive groups such as a chain polymerizable group, an epoxy group, —OH, —OR [here, R represents an alkyl group], —NH₂, —SH, —COOH, and —SiR^{Q1}_{3-Qn}(OR^{Q2})_{Qn} [here, R^{Q1} represents a hydrogen atom, an alkyl group, or a substituted or unsubstituted aryl group, R^{Q2} represents a hydrogen atom, an alkyl group, or a trialkylsilyl group, and Qn represents an integer of 1 to 3].

The chain polymerizable group is not particularly limited as long as the group is a functional group capable of radical polymerization, and is, for example, a functional group having a group containing at least carbon double bond. Specific examples thereof include a vinyl group, a vinyl ether group, a vinyl thioether group, a styryl group (vinylphenyl group), an acryloyl group, a methacryloyl group, and a group containing at least one selected from derivatives thereof. Among the above, from the viewpoint that reactivity is excellent, for example, a vinyl group, a styryl group (vinylphenyl group), an acryloyl group, a methacryloyl group, or a group containing at least one selected from derivatives thereof is preferable as the chain polymerizable group.

The charge-transporting skeleton of the reactive group-containing charge transport material is not particularly limited as long as the skeleton is a known structure in the electrophotographic photoreceptor, and examples thereof include a structure conjugated with a nitrogen atom, which is a skeleton derived from a nitrogen-containing positive hole-transporting compound such as a triarylamine-based compound, a benzidine-based compound, and a hydrazone-based compound. Among the above, for example, a triarylamine skeleton is preferable.

The reactive group-containing charge transport material having the reactive group and the charge-transporting skeleton, the non-reactive charge transport material, and the reactive group-containing non-charge transport material may be selected from known materials.

The protective layer may also contain other known additives.

The formation of the protective layer is not particularly limited, and a known forming method is used. For example, a coating film of a coating solution for forming the protective layer, in which the above-described components are added to a solvent, is formed, and the coating film is dried and then subjected to a curing treatment such as heating as necessary.

Examples of the solvent for preparing the coating solution for forming the protective layer include an aromatic solvent such as toluene and xylene; a ketone-based solvent such as methyl ethyl ketone, methyl isobutyl ketone, and cyclohexanone; an ester-based solvent such as ethyl acetate and butyl acetate; an ether-based solvent such as tetrahydrofuran and dioxane; a cellosolve-based solvent such as ethylene glycol monomethyl ether; and an alcohol-based solvent such as isopropyl alcohol and butanol. The solvents are used alone or in a form of a mixture of two or more kinds thereof.

The coating solution for forming the protective layer may be a solvent-less coating solution.

Examples of the method of coating the photosensitive layer (for example, the charge transport layer) with the coating solution for forming the protective layer include typical methods such as a dip coating method, a push-up coating method, a wire bar coating method, a spray coating method, a blade coating method, an air knife coating method, and a curtain coating method.

A film thickness of the protective layer is set to, for example, preferably in a range of 1 μm or more and 20 μm or less and more preferably in a range of 2 μm or more and 10 μm or less.

### Single Layer-Type Photosensitive Layer

A single layer-type photosensitive layer (charge generation/charge transport layer) is, for example, a layer containing a charge generation material, a charge transport material, and as necessary, a binder resin and other known additives. The materials are the same as the materials described in the sections of the charge generation layer and the charge transport layer.

A content of the charge generation material in the single layer-type photosensitive layer may be, for example, 0.1% by mass or more and 10% by mass or less, preferably 0.8% by mass or more and 5% by mass or less with respect to the total solid content. In addition, a content of the charge transport material in the single layer-type photosensitive layer may be, for example, 5% by mass or more and 50% by mass or less with respect to the total solid content.

A method of forming the single layer-type photosensitive layer is the same as the method of forming the charge generation layer or the charge transport layer.

A film thickness of the single layer-type photosensitive layer may be, for example, 5 μm or more and 50 μm or less, preferably 10 μm or more and 40 μm or less.

### Configuration of Image Forming Apparatus (and Process Cartridge)

The image forming apparatus according to the present exemplary embodiment includes an image holder; a charging unit that charges a surface of the image holder; an electrostatic charge image forming unit that forms an electrostatic charge image on the charged surface of the image holder; a developing unit that accommodates an electrostatic charge image developer containing a toner having toner particles and develops the electrostatic charge image formed on the surface of the image holder as a toner image using the electrostatic charge image developer; a transferring unit that transfers the toner image formed on the surface of the image holder to a surface of a recording medium; and a cleaning device having a cleaning blade that is brought into contact with an outer peripheral surface of the image holder for cleaning the image holder.

The toner particles and the cleaning blade have the above-described configurations.

As the image forming apparatus according to the present exemplary embodiment, a known image forming apparatus is applied that includes a device including a transferring unit that transfers the toner image on the image holder onto the recording medium through a secondary transfer member (for example, a secondary transfer belt); a device including a fixing unit that fixes the toner image transferred to the surface of the recording medium; a device including a cleaning device that cleans the surface of the image holder after the transfer of the toner image and before the charging; a device including an electricity removing device that removes electricity by irradiating the surface of the image holder after the transfer of the toner image and before the charging, with electricity removing light; a device including an image holder heating member that raises the temperature of the image holder to reduce relative temperature; and the like.

The image forming apparatus according to the present exemplary embodiment may be any of a dry development-type image forming apparatus or a wet development-type (development type using a liquid developer) image forming apparatus.

In the image forming apparatus according to the present exemplary embodiment, for example, a portion including the image holder may have a cartridge structure (process cartridge) that is attachable to and detachable from the image forming apparatus. As the process cartridge, for example, a process cartridge including a toner image forming device and a transfer device is preferably used.

### Image Forming Method

The image forming method according to the present exemplary embodiment includes a charging step of charging a surface of an image holder; an electrostatic charge image forming step of forming an electrostatic charge image on the charged surface of the image holder; an electrostatic charge image developing step of developing the electrostatic charge image formed on the surface of the image holder using an electrostatic charge image developing toner containing toner particles to form a toner image; a transferring step of transferring the toner image to a surface of a recording medium; and a cleaning step of contacting a cleaning blade with the surface of the image holder to clean the surface.

The toner particles and the cleaning blade have the above-described configurations.

Hereinafter, an example of the image forming apparatus and the image forming method according to the present exemplary embodiment will be described with reference to drawing. Here, the image forming apparatus and the image forming method according to the present exemplary embodiment are not limited thereto. Hereinafter, among the parts shown in the drawing, main parts will be described, and others will not be described.

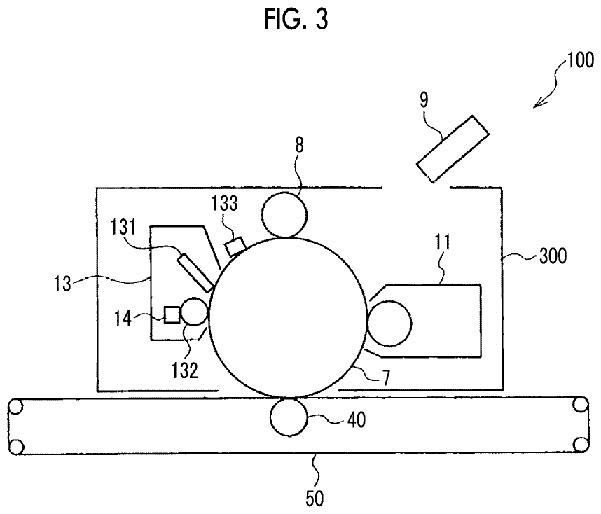

FIG. 3 is a view schematically showing a configuration of an example of the image forming apparatus according to the present exemplary embodiment.

As shown in FIG. 3, an image forming apparatus 100 according to the present exemplary embodiment includes a process cartridge 300 including an electrophotographic photoreceptor 7 (an example of the image holder), an exposure device 9 (an example of the electrostatic charge image forming unit), a transfer device 40 (a primary transfer device), and an intermediate transfer member 50. In the image forming apparatus 100, the exposure device 9 is disposed at a position that can be exposed to the electrophotographic photoreceptor 7 from an opening portion of the process cartridge 300; the transfer device 40 is disposed at a position that faces the electrophotographic photoreceptor 7 through the intermediate transfer member 50; and the intermediate transfer member 50 is disposed such that a part of the intermediate transfer member 50 is in contact with the electrophotographic photoreceptor 7. Although not shown, the image forming apparatus also includes a secondary transfer device that transfers the toner image transferred to the intermediate transfer member 50 to a recording medium (for example, paper). The intermediate transfer member 50, the transfer device 40 (primary transfer device), and the secondary transfer device (not shown) correspond to an example of the transferring unit.

The process cartridge 300 in FIG. 3 integrally supports the electrophotographic photoreceptor 7, a charging device 8 (an example of the charging unit), a developing device 11 (an example of the developing unit), and a cleaning device 13 in a housing. The cleaning device 13 has a cleaning blade 131, and the cleaning blade 131 is disposed to come into contact with the surface of the electrophotographic photoreceptor 7. The cleaning member may be a conductive or insulating fibrous member instead of the aspect of the cleaning blade 131, and may be used alone or in combination with the cleaning blade 131.

FIG. 3 shows an example of an image forming apparatus including a fibrous member 132 (roll shape) that supplies a lubricant 14 to the surface of the electrophotographic photoreceptor 7 and a fibrous member 133 (flat brush shape) that assists the cleaning, but these are disposed as necessary.

Hereinafter, each configuration of the image forming apparatus according to the present exemplary embodiment will be described.

### Charging Device

As the charging device 8, for example, a contact-type charger formed of a conductive or semi-conductive charging roller, a charging brush, a charging film, a charging rubber blade, a charging tube, or the like is used. In addition, a known charger such as a non-contact type roller charger, and a scorotron charger or a corotron charger using corona discharge is also used.

### Exposure Device

Examples of the exposure device 9 include an optical system device that exposes the surface of the electrophotographic photoreceptor 7 to light such as a semiconductor laser beam, LED light, and liquid crystal shutter light in a predetermined image pattern. A wavelength of the light source is within the spectral sensitivity region of the electrophotographic photoreceptor. As a wavelength of a semiconductor laser, near infrared laser, which has an oscillation wavelength in the vicinity of 780 nm, is mostly used. However, the wavelength is not limited thereto, and a laser having an oscillation wavelength of an approximately 600 nm level or a laser having an oscillation wavelength of 400 nm or greater and 450 nm or less as a blue laser may also be used. In addition, a surface emission-type laser light source capable of outputting a multi-beam is also effective for forming a color image.

### Developing Device

Examples of the developing device 11 include a typical developing device that performs development in contact or non-contact with the developer. The developing device 11 is not particularly limited as long as the device has the above-described functions, and is selected depending on the purpose thereof. Examples thereof include known developing machines having a function of attaching a one-component developer or a two-component developer to the electrophotographic photoreceptor 7 using a brush, a roller, or the like. Among the above, for example, a developing roller in which a developer is retained on a surface is preferably used.

The developer used in the developing device 11 may be a one-component developer containing only a toner or a two-component developer containing a toner and a carrier. In addition, the developer may be magnetic or non-magnetic. Known developers are employed as the developer.

### Cleaning Device

As the cleaning device 13, a cleaning blade-type device including the cleaning blade 131 is used.

### Transfer Device

Examples of the transfer device 40 include a known transfer charger such as a contact type transfer charger using a belt, a roller, a film, a rubber blade, or the like, and a scorotron transfer charger or a corotron transfer charger using corona discharge.

### Intermediate Transfer Member

As the intermediate transfer member 50, a semi-conductive belt-like intermediate transfer member (intermediate transfer belt) containing polyimide, polyamide-imide, polycarbonate, polyarylate, polyester, rubber, or the like is used. In addition, as the form of the intermediate transfer member, a drum-like intermediate transfer member may be used in addition to the belt-like intermediate transfer member.

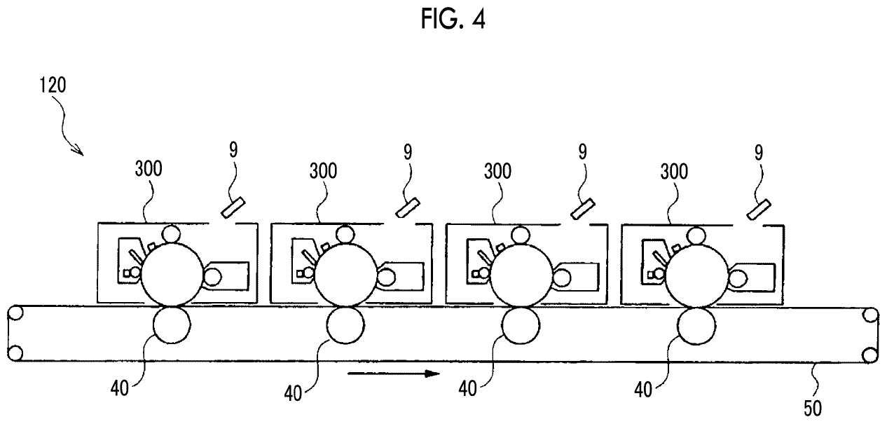

FIG. 4 is a view schematically showing a configuration of another example of the image forming apparatus according to the present exemplary embodiment.

An image forming apparatus 120 shown in FIG. 4 is a tandem type multicolor image forming apparatus in which four process cartridges 300 are mounted. The image forming apparatus 120 is formed such that the four process cartridges 300 are arranged in parallel on the intermediate transfer member 50, and one electrophotographic photoreceptor is used for each color. The image forming apparatus 120 has the same configuration as the image forming apparatus 100, except that the image forming apparatus 120 is of a tandem type.

The present exemplary embodiment has been described above, but the present invention is not limited to the above-described embodiments, and may be modified, changed, and improved in various ways.

### EXAMPLES

Examples of the present disclosure will be described below, but the present disclosure is not limited to Examples. In the following description, unless otherwise specified, “parts” and “%” are based on mass.

### Example 1

### Production of Developer

### Preparation of Metal Pigment Dispersion

Aluminum pigment (manufactured by Showa Aluminum Powder Ltd., 2173EA): 100 parts
Anionic surfactant (manufactured by DKS Co. Ltd., NEOGEN R): 1.5 parts
Deionized water: 400 parts

A solvent is removed from a paste of the aluminum pigment, and the pigment is mechanically pulverized and classified using a starmill (manufactured by Ashizawa Finetech Ltd., LMZ). Thereafter, the above-described active agent and deionized water are mixed therewith, and dispersed for approximately 1 hour using an emulsification disperser CAVITRON (manufactured by Taihei Kogyo Co., Ltd., CR1010) to prepare a metal pigment dispersion in which metal pigment particles (aluminum pigment) are dispersed (concentration of solid contents: 20%). An average equivalent circle diameter of the dispersion is 15 μm.

### Synthesis of Amorphous Polyester Resin

Ethylene oxide (2.2 mol) adduct of bisphenol A: 40 mol %
Propylene oxide (2.2 mol) adduct of bisphenol A: 60 mol %
Terephthalic acid: 47 mol %
Fumaric acid: 40 mol %
Dodecenyl succinic acid anhydride: 15 mol %
Trimellitic acid anhydride: 3 mol %

A reaction container equipped with a stirrer, a thermometer, a condenser, and a nitrogen gas introduction pipe is charged with 0.25 parts of dioctanoyltin, other than fumaric acid and trimellitic acid anhydride among the above-described monomer components, with respect to the total of 100 parts of the above-described monomer components. The mixture is allowed to react at 235° C. for 6 hours in a nitrogen gas stream and cooled to 200° C., the fumaric acid and the trimellitic acid anhydride described above are added to the mixture, and the mixture is allowed to react for 1 hour. The temperature is raised to 220° C. over 4 hours, the mixture is polymerized under a pressure of 10 kPa until a target molecular weight is obtained to obtain a pale yellow transparent amorphous polyester resin.

As the measurement results for the obtained amorphous polyester resin, a glass transition temperature Tg measured by DSC is 59° C., a mass-average molecular weight Mw measured by GPC is 25,000, a number-average molecular weight Mn is 7,000, a softening temperature measured by a flow tester is 107° C., and an acid value AV is 13 mgKOH/g.

### Preparation of Amorphous Polyester Resin Dispersion

In a state in which a 3 L reaction vessel equipped with a jacket (BJ-30N, manufactured by Tokyo Rikakikai Co., Ltd.) including a condenser, a thermometer, a water dripping device, and an anchor blade is maintained at 40° C. in a water circulation type constant temperature vessel, a mixed solution of 160 parts of ethyl acetate and 100 parts of isopropyl alcohol is put into the reaction vessel, 300 parts of the above-described amorphous polyester resin is put into the reaction vessel, and the solution is stirred at 150 rpm using a three-one motor for dissolution, thereby obtaining an oil phase. 14 parts of a 10% ammonia aqueous solution is added dropwise to the oil phase while being stirred for a dripping time of 5 minutes and mixed for 10 minutes, and 900 parts of deionized water is further added thereto at a rate of 7 parts/min to invert the phase, thereby obtaining an emulsified liquid.

Immediately, 800 parts of the obtained emulsified liquid and 700 parts of deionized water are put in a 2 L eggplant flask and set in an evaporator (manufactured by Tokyo Rikakikai Co., Ltd.) equipped with a vacuum controlled unit through a trap ball. While being rotated, the eggplant flask is heated in a hot water bath at 60° C., and the pressure is reduced to 7 kPa with care to sudden boiling, thereby removing the solvent. At a point in time when the amount of solvent collected reaches 1,100 parts, the pressure is returned to normal pressure, and the eggplant flask is cooled in water, thereby obtaining a dispersion. The obtained dispersion has no solvent odor. A volume-average particle size D50v of the resin particles in the dispersion is 130 nm. In the following, as the volume-average particle size D50v, an average value of three measured values excluding the maximum value and the minimum value among five measurements using a microtrac is used.

Thereafter, deionized water is added thereto to adjust the concentration of solid contents to 20%, and the resultant is used as an amorphous polyester resin dispersion.

### Synthesis of Crystalline Polyester Resin

1,10-Dodecanedioic acid: 50 mol %
1,9-Nonanediol: 50 mol %

The above-described monomer components are charged into a reaction container equipped with a stirrer, a thermometer, a condenser, and a nitrogen gas introduction tube, the inside of the reaction container is replaced with dry nitrogen gas, and 0.25 parts of titanium tetrabutoxide (reagent) is added to 100 parts of the above-described monomer components. The mixture is stirred and allowed to react at 170° C. for 3 hours in a nitrogen gas stream and further heated to a temperature of 210° C. for 1 hour, the pressure the inside of the reaction container is reduced to 3 kPa, and the mixture is stirred and allowed to react under reduced pressure for 13 hours, thereby obtaining a crystalline polyester resin.

As the measurement results of the obtained crystalline polyester resin, a melting temperature measured by DSC is 73.6° C., a mass-average molecular weight Mw measured by GPC is 25,000, a number-average molecular weight Mn is 10,500, and an acid value AV is 10.1 mgKOH/g.

Preparation of Crystalline Polyester Resin Particle Dispersion 300 parts of the above-described crystalline polyester resin, 160 parts of methyl ethyl ketone (solvent), and 100 parts of isopropyl alcohol (solvent) are put into a 3 L reaction vessel equipped with a jacket (BJ-30N, manufactured by Tokyo Rikakikai Co., Ltd.) including a condenser, a thermometer, a water dripping device, and an anchor blade, and the resin is dissolved by stirring and mixing at 100 rpm while maintaining the temperature at 70° C. in a water circulation type constant temperature vessel (dissolved solution preparation step).

Thereafter, the stirring rotation speed is set to 150 rpm, the temperature of the water circulation type constant temperature vessel is set to 66° C., 17 parts of 10% ammonia water (reagent) is added thereto over 10 minutes, and a total of 900 parts of deionized water that has been warmed to 66° C. is added dropwise to the solution at a rate of 7 parts/min for phase inversion, thereby obtaining an emulsified liquid.

Immediately, 800 parts of the obtained emulsified liquid and 700 parts of deionized water are put in a 2 L eggplant flask and set in an evaporator (manufactured by Tokyo Rikakikai Co., Ltd.) equipped with a vacuum controlled unit through a trap ball. While being rotated, the eggplant flask is heated in a hot water bath at 60° C., and the pressure is reduced to 7 kPa with care to sudden boiling, thereby removing the solvent. At a point in time when the amount of solvent collected reaches 1,100 parts, the pressure is returned to normal pressure, and the eggplant flask is cooled in water, thereby obtaining a dispersion. The obtained dispersion has no solvent odor. A volume-average particle size D50v of the resin particles in the dispersion is 130 nm. Thereafter, deionized water is added thereto to adjust the concentration of solid contents to 20%, and the resultant is used as a crystalline polyester resin dispersion.

### Production of Toner

Amorphous polyester resin dispersion: 263 parts
Crystalline polyester resin dispersion: 12 parts
Metal pigment dispersion: 100 parts
Nonionic surfactant (IGEPAL CA897): 2.5 parts

The above-described raw materials are put into a 2 L cylindrical stainless steel container, and dispersed and mixed together for 10 minutes in a state where a shearing force is applied at 4,000 rpm by a homogenizer (ULTRA-TURRAX T50 manufactured by IKA). Next, 60 parts of a 10% nitric acid aqueous solution of polyaluminum chloride as an aggregating agent is slowly added dropwise to the mixture, and dispersed and mixed for 15 minutes by the homogenizer at a rotation speed of 5,000 rpm, thereby obtaining a raw material dispersion.

Thereafter, the raw material dispersion is moved to a polymerization tank equipped with a stirrer using two paddles as stirring blades and a thermometer, and start to be heated with a mantle heater at a rotation speed for stirring of 857 rpm, and then the growth of aggregated particles is promoted at 54° C. In this case, by using an aqueous solution of 0.3 N nitric acid or 1 N sodium hydroxide, the pH of the raw material dispersion is controlled in a range of 2.2 to 3.5. The raw material dispersion is retained in the above-described pH range for approximately 2 hours so that aggregated particles are formed.

Next, 125 parts of the amorphous polyester resin dispersion is further added thereto, and the resin particles of the binder resin are attached to the surface of the aggregated particles.

Thereafter, the temperature is raised to 56° C., and the aggregated particles are arranged while confirming the size and the shape of the particles with an optical microscope and MULTISIZER II. Thereafter, 4.25 parts of a chelating agent (HIDS, manufactured by NIPPON SHOKUBAI CO., LTD.) is added thereto, the pH is adjusted to 7.8 using a 5% sodium hydroxide aqueous solution, and the mixture is allowed to stand for 15 minutes. Thereafter, the pH is raised to 8.0 so that the aggregated particles are fused, and then the dispersion is heated up to 66.5° C. After confirming with an optical microscope that the aggregated particles are fused with each other, the pH is lowered to 6.0 while maintaining the temperature at 66.5° C., the heating is stopped after 1 hour, and the solution is cooled at a cooling rate of 1.0° C./min. Subsequently, the particles are sieved with a 20 μm mesh, repeatedly washed with water, and then dried in a vacuum dryer, thereby obtaining toner particles. For the obtained toner particles, a volume-average particle diameter is 17.2 μm, an average value of the ratio b/a is 0.5, and a pigment area ratio is 0.7.

1.5 parts of silica particles (RY50 manufactured by Nippon Aerosil Co., Ltd.) are mixed with 100 parts of the toner particles at a circumferential speed of 30 m/see for 3 minutes using a Henschel mixer (manufactured by MITSUI MIIKE MACHINERY). Thereafter, the mixture is sieved using a vibration sieve having an opening of 45 μm, thereby producing a toner.

### Production of Carrier

Ferrite particles (volume-average particle diameter: 35 m): 100 parts
Toluene: 14 parts
Perfluoroacrylate copolymer (critical surface tension: 24 dyn/cm): 1.6 parts
Carbon black (product name: VXC-72, manufactured by Cabot Corporation., volume resistivity: 100 Ωcm or less): 0.12 parts
Crosslinked melamine resin particles (average particle diameter: 0.3 μm, insoluble in toluene): 0.3 parts

First, the carbon black is diluted with toluene and added to the perfluoroacrylate copolymer, and the mixture is dispersed with a sand mill. Next, the above-described respective components other than the ferrite particles are dispersed in the mixture with a stirrer for 10 minutes to prepare a solution for forming a coating layer. Next, the solution for forming a coating layer and the ferrite particles are placed in a vacuum degassing kneader, stirred at a temperature of 60° C. for 30 minutes, and then distilled off under reduced pressure to form a resin coating layer, thereby obtaining a carrier.

### Production of Developer

36 parts of the above-described toner and 414 parts of the above-described carrier are placed in a 2 liter V-blender, stirred for 20 minutes, and then sieved through 212 μm to produce a developer.

### Production of Cleaning Blade

### Front Surface Layer Composition

A polyester polyol (PEPO) polymerized with a linear diol having 4 carbon atoms (butanediol) is obtained in which adipic acid (HOOC—C₄H₈—COOH) and 1,4-butanediol are polymerized and treated such that the terminal is-OH. A weight-average molecular weight of the obtained polyester polyol is as described in Table 1. The above-described polyester polyol as a polyol component, 4,4′-diphenylmethane diisocyanate (MDI, polyisocyanate, manufactured by Nippon Polyurethane Industry Co., Ltd., MILLIONATE MT) as an isocyanate component, and a crosslinking agent (trimethylolpropane (TMP), manufactured by Mitsubishi Gas Chemical Company, Inc.) are adjusted to a molar ratio described in Table 1, and reacted at 80° C. for 2 hours under a nitrogen atmosphere to prepare a front surface layer composition A1 for forming a cleaning blade.

### Back Surface Layer Composition

In addition, a back surface layer composition A2 is prepared by, in the above-described front surface layer composition A1, changing the weight-average molecular weight of the polyester polyol (PEPO) and the molar ratio of the polyester polyol (PEPO), the 4,4′-diphenylmethane diisocyanate (MDI), and the crosslinking agent (TMP) as described in Table 1.

### Production of Cleaning Blade

Next, the above-described back surface layer composition A2 is poured into a central portion of a mold, the temperature of the mold is raised to adjust the mold temperature to 140° C., the above-described front surface layer composition A1 is poured thereto after 10 minutes, and a curing reaction is carried out for 1 hour. Next, the product is aged and heated at 110° C. for 24 hours, cooled, and cut to obtain a cleaning blade having a width of 8 mm and a thickness of 2 mm (thickness of the front surface layer: 0.5 mm, thickness of the back surface layer: 1.5 mm) formed of a front surface layer and a back surface layer that come into contact with a cleaning target member (that is, an image holder).

### Example 2

### Production of Developer

A toner is produced by the same method as in Example 1, except that a metal pigment having an average equivalent circle diameter adjusted to 5 μm is used, and the produced toner is subjected to a ball milling treatment. For the obtained toner particles, a volume-average particle diameter is 7.5 μm, an average value of the ratio b/a is 0.5, and a pigment area ratio is 0.5.

### Production of Cleaning Blade

A cleaning blade is produced by the same method as in Example 1, except that, in Example 1, the weight-average molecular weight of the polyester polyol (PEPO) and the molar ratio of the polyester polyol (PEPO), the 4,4′-diphenylmethane diisocyanate (MDI), and the crosslinking agent (TMP) in the front surface layer composition A1, and the weight-average molecular weight of the polyester polyol (PEPO) and the molar ratio of the polyester polyol (PEPO), the 4,4′-diphenylmethane diisocyanate (MDI), and the crosslinking agent (TMP) in the back surface layer composition A2 are changed as described in Table 1.

### Example 3

### Production of Developer

A toner is produced by the same method as in Example 1, except that a metal pigment having an average equivalent circle diameter adjusted to 10 μm is used and the method of producing the toner is changed as follows.
Amorphous polyester resin dispersion: 215 parts
Crystalline polyester resin dispersion: 60 parts
Metal pigment dispersion: 100 parts
Nonionic surfactant (IGEPAL CA897): 2.5 parts

For the obtained toner particles, a volume-average particle diameter is 12.3 μm, an average value of the ratio b/a is 0.65, and a pigment area ratio is 0.6.

### Production of Cleaning Blade

A cleaning blade is produced by the same method as in Example 1, except that, in Example 1, the weight-average molecular weight of the polyester polyol (PEPO) and the molar ratio of the polyester polyol (PEPO), the 4,4′-diphenylmethane diisocyanate (MDI), and the crosslinking agent (TMP) in the front surface layer composition A1, and the weight-average molecular weight of the polyester polyol (PEPO) and the molar ratio of the polyester polyol (PEPO), the 4,4′-diphenylmethane diisocyanate (MDI), and the crosslinking agent (TMP) in the back surface layer composition A2 are changed as described in Table 1.

### Example 4

### Production of Developer

A toner is produced by the same method as in Example 1, except that the method of producing the toner is changed as follows.
Amorphous polyester resin dispersion: 155 parts
Crystalline polyester resin dispersion: 120 parts
Metal pigment dispersion: 100 parts
Nonionic surfactant (IGEPAL CA897): 2.5 parts

For the obtained toner particles, a volume-average particle diameter is 17.5 μm, an average value of the ratio b/a is 0.8, and a pigment area ratio is 0.7.

### Production of Cleaning Blade

A cleaning blade is produced by the same method as in Example 1, except that, in Example 1, the weight-average molecular weight of the polyester polyol (PEPO) and the molar ratio of the polyester polyol (PEPO), the 4,4′-diphenylmethane diisocyanate (MDI), and the crosslinking agent (TMP) in the front surface layer composition A1, and the weight-average molecular weight of the polyester polyol (PEPO) and the molar ratio of the polyester polyol (PEPO), the 4,4′-diphenylmethane diisocyanate (MDI), and the crosslinking agent (TMP) in the back surface layer composition A2 are changed as described in Table 1.

### Example 5

### Production of Developer

A toner is produced by the same method as in Example 1, except that a metal pigment having an average equivalent circle diameter adjusted to 5 μm is used and the method of producing the toner is changed as follows.
Amorphous polyester resin dispersion: 155 parts
Crystalline polyester resin dispersion: 120 parts
Metal pigment dispersion: 100 parts
Nonionic surfactant (IGEPAL CA897): 2.5 parts

For the obtained toner particles, a volume-average particle diameter is 7.6 μm, an average value of the ratio b/a is 0.8, and a pigment area ratio is 0.5.

### Production of Cleaning Blade

A cleaning blade is produced by the same method as in Example 1, except that, in Example 1, the weight-average molecular weight of the polyester polyol (PEPO) and the molar ratio of the polyester polyol (PEPO), the 4,4′-diphenylmethane diisocyanate (MDI), and the crosslinking agent (TMP) in the front surface layer composition A1, and the weight-average molecular weight of the polyester polyol (PEPO) and the molar ratio of the polyester polyol (PEPO), the 4,4′-diphenylmethane diisocyanate (MDI), and the crosslinking agent (TMP) in the back surface layer composition A2 are changed as described in Table 1.

### Example 6

### Production of Developer

A toner is produced by the same method as in Example 1, except that a metal pigment having an average equivalent circle diameter adjusted to 10 μm is used. For the obtained toner particles, a volume-average particle diameter is 12.1 μm, an average value of the ratio b/a is 0.5, and a pigment area ratio is 0.6.

### Production of Cleaning Blade

A cleaning blade is produced by the same method as in Example 1, except that, in Example 1, the weight-average molecular weight of the polyester polyol (PEPO) and the molar ratio of the polyester polyol (PEPO), the 4,4′-diphenylmethane diisocyanate (MDI), and the crosslinking agent (TMP) in the front surface layer composition A1, and the weight-average molecular weight of the polyester polyol (PEPO) and the molar ratio of the polyester polyol (PEPO), the 4,4′-diphenylmethane diisocyanate (MDI), and the crosslinking agent (TMP) in the back surface layer composition A2 are changed as described in Table 1.

### Example 7

### Production of Developer

A toner is produced by the same method as in Example 4.

### Production of Cleaning Blade

A cleaning blade is produced by the same method as in Example 1, except that, in Example 1, the weight-average molecular weight of the polyester polyol (PEPO) and the molar ratio of the polyester polyol (PEPO), the 4,4′-diphenylmethane diisocyanate (MDI), and the crosslinking agent (TMP) in the front surface layer composition A1, and the weight-average molecular weight of the polyester polyol (PEPO) and the molar ratio of the polyester polyol (PEPO), the 4,4′-diphenylmethane diisocyanate (MDI), and the crosslinking agent (TMP) in the back surface layer composition A2 are changed as described in Table 1.

### Example 8

### Production of Developer

A toner is produced by the same method as in Example 4.

### Production of Cleaning Blade

A cleaning blade is produced by the same method as in Example 1, except that, in Example 1, the weight-average molecular weight of the polyester polyol (PEPO) and the molar ratio of the polyester polyol (PEPO), the 4,4′-diphenylmethane diisocyanate (MDI), and the crosslinking agent (TMP) in the front surface layer composition A1, and the weight-average molecular weight of the polyester polyol (PEPO) and the molar ratio of the polyester polyol (PEPO), the 4,4′-diphenylmethane diisocyanate (MDI), and the crosslinking agent (TMP) in the back surface layer composition A2 are changed as described in Table 2.

### Example 9

### Production of Developer

A toner is produced by the same method as in Example 2.

### Production of Cleaning Blade

A cleaning blade is produced by the same method as in Example 2, except that, in Example 2, the weight-average molecular weight of the polyester polyol (PEPO) and the molar ratio of the polyester polyol (PEPO), the 4,4′-diphenylmethane diisocyanate (MDI), and the crosslinking agent (TMP) in the front surface layer composition A1 are changed as described in Table 2.

### Examples 10 to 20

### Production of Developer

A toner is produced by the same method as in Example 1.

### Production of Cleaning Blade

A cleaning blade is produced by the same method as in Example 1, except that, in Example 1, any of the weight-average molecular weight of the polyester polyol (PEPO) and the molar ratio of the polyester polyol (PEPO), the 4,4′-diphenylmethane diisocyanate (MDI), and the crosslinking agent (TMP) in the front surface layer composition A1, or the weight-average molecular weight of the polyester polyol (PEPO) and the molar ratio of the polyester polyol (PEPO), the 4,4′-diphenylmethane diisocyanate (MDI), and the crosslinking agent (TMP) in the back surface layer composition A2 are changed as described in Table 2 or Table 3.

### Example 21

### Production of Developer

A toner is produced by the same method as in Example 1, except that, in Example 1, the amount of the crystalline resin is changed as described in Table 3.

### Production of Cleaning Blade

A cleaning blade is produced by the same method as in Example 1.

### Comparative Example 1

### Production of Developer

A toner is produced by the same method as in Example 1.

### Production of Cleaning Blade

A cleaning blade is produced by the same method as in Example 1, except that, in Example 1, the weight-average molecular weight of the polyester polyol (PEPO) and the molar ratio of the polyester polyol (PEPO), the 4,4′-diphenylmethane diisocyanate (MDI), and the crosslinking agent (TMP) in the front surface layer composition A1, and the weight-average molecular weight of the polyester polyol (PEPO) and the molar ratio of the polyester polyol (PEPO), the 4,4′-diphenylmethane diisocyanate (MDI), and the crosslinking agent (TMP) in the back surface layer composition A2 are changed as described in Table 4.

### Comparative Example 2

### Production of Developer

A toner is produced by the same method as in Example 4.

### Production of Cleaning Blade

A cleaning blade is produced by the same method as in Example 1, except that, in Example 1, the weight-average molecular weight of the polyester polyol (PEPO) and the molar ratio of the polyester polyol (PEPO), the 4,4′-diphenylmethane diisocyanate (MDI), and the crosslinking agent (TMP) in the front surface layer composition A1, and the weight-average molecular weight of the polyester polyol (PEPO) and the molar ratio of the polyester polyol (PEPO), the 4,4′-diphenylmethane diisocyanate (MDI), and the crosslinking agent (TMP) in the back surface layer composition A2 are changed as described in Table 4.

### Comparative Example 3

A toner is produced by the same method as in Example 1, except that the method of producing the toner is changed as follows.
Amorphous polyester resin dispersion: 271 parts
Crystalline polyester resin dispersion: 4 parts
Metal pigment dispersion: 100 parts
Nonionic surfactant (IGEPAL CA897): 2.5 parts

For the obtained toner particles, a volume-average particle diameter is 17.3 μm, an average value of the ratio b/a is 0.4, and a pigment area ratio is 0.7.

### Production of Cleaning Blade

A cleaning blade is produced by the same method as in Example 1, except that, in Example 1, the weight-average molecular weight of the polyester polyol (PEPO) and the molar ratio of the polyester polyol (PEPO), the 4,4′-diphenylmethane diisocyanate (MDI), and the crosslinking agent (TMP) in the front surface layer composition A1, and the weight-average molecular weight of the polyester polyol (PEPO) and the molar ratio of the polyester polyol (PEPO), the 4,4′-diphenylmethane diisocyanate (MDI), and the crosslinking agent (TMP) in the back surface layer composition A2 are changed as described in Table 4.

### Comparative Example 4

A toner is produced by the same method as in Example 1, except that a metal pigment having an average equivalent circle diameter adjusted to 5 μm is used and the method of producing the toner is changed as follows, and then the produced toner is subjected to a ball milling treatment.
Amorphous polyester resin dispersion: 271 parts
Crystalline polyester resin dispersion: 4 parts
Metal pigment dispersion: 100 parts
Nonionic surfactant (IGEPAL CA897): 2.5 parts

For the obtained toner particles, a volume-average particle diameter is 7.4 μm, an average value of the ratio b/a is 0.4, and a pigment area ratio is 0.5.

### Production of Cleaning Blade

A cleaning blade is produced by the same method as in Example 1, except that, in Example 1, the weight-average molecular weight of the polyester polyol (PEPO) and the molar ratio of the polyester polyol (PEPO), the 4,4′-diphenylmethane diisocyanate (MDI), and the crosslinking agent (TMP) in the front surface layer composition A1, and the weight-average molecular weight of the polyester polyol (PEPO) and the molar ratio of the polyester polyol (PEPO), the 4,4′-diphenylmethane diisocyanate (MDI), and the crosslinking agent (TMP) in the back surface layer composition A2 are changed as described in Table 4.

### Comparative Example 5

### Production of Developer

A toner is produced by the same method as in Comparative Example 3.

### Production of Cleaning Blade

A cleaning blade is produced by the same method as in Example 1, except that, in Example 1, the weight-average molecular weight of the polyester polyol (PEPO) and the molar ratio of the polyester polyol (PEPO), the 4,4′-diphenylmethane diisocyanate (MDI), and the crosslinking agent (TMP) in the front surface layer composition A1, and the weight-average molecular weight of the polyester polyol (PEPO) and the molar ratio of the polyester polyol (PEPO), the 4,4′-diphenylmethane diisocyanate (MDI), and the crosslinking agent (TMP) in the back surface layer composition A2 are changed as described in Table 4.

### Comparative Examples 6 and 7

### Production of Developer

A toner is produced by the same method as in Example 2.

### Production of Cleaning Blade

A cleaning blade is produced by the same method as in Example 2, except that, in Example 2, the molar ratio of the polyester polyol (PEPO), the 4,4′-diphenylmethane diisocyanate (MDI), and the crosslinking agent (TMP) in the front surface layer composition A1 is changed as described in Table 4.

### Physical Properties of Cleaning Blade

For the cleaning blades obtained in each of Examples and Comparative Examples, the breaking energy, the 100% modulus at the contact portion with the image holder, and the crosslinking density of the front surface layer are measured by the above-described methods. In addition, the 100% modulus, the permanent elongation, and the crosslinking density of the back surface layer are also measured by the above-described methods. The results are shown in Tables 1 to 4. In the crosslinking densities shown in Tables 1 to 4, for example, “1.00E-03” indicates “1.00×10⁻³”, and the same applies to other values.

### Evaluation

### Formation of Evaluation Image

An evaluation image is formed by the following method.

A developer as a sample is filled in a developing machine of DocuCentre-III C7600 manufactured by FUJIFILM Business Innovation Corp., and a solid image with a toner coverage of 4.5 g/m² is formed on recording paper (C2 paper, manufactured by FUJIFILM Business Innovation Japan Co., Ltd.; smoothness measured based on JIS P 8119:1998 is 90 seconds) at a fixing temperature of 190° C. and a fixing pressure of 4.0 kg/cm².

### Evaluation of Photoluminescence

Regarding the obtained solid image, photoluminescence is visually evaluated under color observation lighting (natural daylight lighting) according to JIS K 5600-4-3: 1999 “General Test Method for Paints-Part 4: Visual Characteristics of Coating Films-Section 3: Visual Comparison of Colors”. The evaluation is performed based on the following standard for particle feeling (effect of shining photoluminescence) and optical effect (change in hue depending on the viewing angle). 2 or more are levels that can actually be used.
5: the particle feeling and the optical effect are in harmony with each other.
4: there are slight particle feeling and optical effect.
3: there is ordinary feeling.
2: the image has a slightly blurred feeling.
1: there is no particle feeling and optical effect at all.

### Evaluation of Abrasion Resistance of Image

With regard to recording paper on which the solid image is formed as described above, 25 sheets of recording paper (C2 paper, manufactured by FUJIFILM Business Innovation Japan Co., Ltd.) are disposed on a side where the solid image is formed, and 25 sheets of recording paper (C2 paper, manufactured by FUJIFILM Business Innovation Japan Co., Ltd.) are disposed on a side opposite to the side where the solid image is formed, thereby obtaining a bundle of 51 sheets of the recording paper. This bundle is set in an automatic document feeding device of a modified machine of DocuCentre C7550 manufactured by FUJIFILM Business Innovation Corp., and the images are rubbed by feeding the documents one by one. After all of the 51 sheets of the recording paper are fed, the same operation is repeated by bundling the sheets again and applying a rubbing load to the image using the automatic document feeding device. After applying a total of 50 times of the rubbing load, photoluminescence of the solid image after applying the rubbing load is evaluated based on the following standard in the same manner as in the evaluation of photoluminescence described above. In a case where the recording paper is transported by the automatic document feeding device, a method of transporting the recording paper is adjusted so that the solid image is in contact with a roller of the automatic document feeding device. 2 or more are levels that can actually be used.
5: the image surface is smooth, and the particle feeling and the optical effect are in harmony with each other.
4: almost no scratch is found on the image surface, and there are particle feeling and optical effect.
3: the image surface has slight scratches, but there is ordinary feeling.
2: the image surface has a slight number of scratches, and there is blurred feeling.
1: the image surface has many scratches, and there is no particle feeling and optical effect at all.

### Measurement of Wear Amount of Blade

The cleaning blade obtained in each example is mounted on a DocuCentre-IV C5575 manufactured by FUJIFILM Business Innovation Japan Co., Ltd., and 200,000 images are formed in a high-temperature and high-humidity environment (28° C./85% RH) with a normal force (NF) of 2.0 gf/mm and a working angle (W/A) of 11°. Thereafter, 200,000 images are formed in a low-temperature and low-humidity environment (10° C./15% RH) with a normal force (NF) of 2.0 gf/mm and a working angle (W/A) of 11°, thereby forming a total of 400,000 images. As an amount of abrasion of a tip of the cleaning blade, a cross-sectional area of a worn portion is measured by observing a cross-sectional profile with a laser microscope VK-9500 manufactured by KEYENCE Corporation.

For example, it is preferable that the amount of abrasion of the cleaning blade is 3 μm² or less (for example, toner leakage is suppressed), and it is not preferable that the amount of abrasion of the cleaning blade is more than 3 μm² (for example, toner leakage is observed).

### Evaluation of Toner Leakage

As an index of toner leakage, the presence or absence of toner remaining on the image holder after the formation of the total of 400,000 images in the “measurement of the amount of abrasion of the blade” described above is confirmed, and determined according to the following evaluation standard.
A: no toner is confirmed on the image holder.
B: toner is confirmed on the image holder, but is within an allowable range.
C: the toner is significantly confirmed on the image holder, that is unacceptable.

### Image Evaluation

200,000 sheets of image formation are performed as in the image formation of the solid image in “Formation of Evaluation Image”, except that the recording paper is changed to “C2r paper, manufactured by FUJIFILM Business Innovation Japan Co., Ltd.”. Thereafter, a degree of deformation of the cleaning blade and occurrence state of image defect of color streaks are observed and visually evaluated according to the following standard.
A: no color streaks are confirmed.
B: color streaks are slightly confirmed in the image, but are within an allowable range.
C: color streaks are confirmed in the image, that is not acceptable.

TABLE 1

| | | | | Example | Example | Example | Example | Example | Example | Example |
|---|---|---|---|---|---|---|---|---|---|---|
| | | | | 1 | 2 | 3 | 4 | 5 | 6 | 7 |
| Toner particles | | Average equivalent circle diameter of | | 15 | 5 | 10 | 15 | 5 | 10 | 15 |
| | | pigment (μm) | | | | | | | | |
| | | Amount of crystalline resin (% by | | 3 | 3 | 15 | 30 | 30 | 3 | 30 |
| | | mass) | | | | | | | | |
| | | Average value of ratio (b/a) | | 0.5 | 0.5 | 0.65 | 0.8 | 0.8 | 0.5 | 0.8 |
| | | Average value of pigment area ratio | | 0.7 | 0.5 | 0.6 | 0.7 | 0.5 | 0.6 | 0.7 |
| Cleaning | Front | Polyol | Type | PEPO | PEPO | PEPO | PEPO | PEPO | PEPO | PEPO |
| blade | surface | | Molecular weight | 8000 | 2000 | 5000 | 8000 | 8000 | 4000 | 8000 |
| | layer | | Molar ratio | 64.2 | 63.5 | 64 | 64.2 | 59.4 | 59.5 | 64.2 |
| | | | (mol %) | | | | | | | |
| | | Crosslinking | Type | TMP | TMP | TMP | TMP | TMP | TMP | TMP |
| | | agent | Molar ratio | 0.8 | 1.5 | 1 | 0.8 | 0.6 | 0.5 | 0.8 |
| | | | (mol %) | | | | | | | |
| | | Isocyanate | Type | MDI | MDI | MDI | MDI | MDI | MDI | MDI |
| | | | Molar ratio | 35 | 35 | 35 | 35 | 40 | 40 | 35 |
| | | | (mol %) | | | | | | | |
| | | Characteristics | Breaking energy | 10000 | 5000 | 8200 | 10000 | 15000 | 15000 | 10000 |
| | | | (MPa · %) | | | | | | | |
| | | | 100% Modulus | 15 | 10 | 12 | 15 | 20 | 10 | 15 |
| | | | (MPa) | | | | | | | |
| | | | Crosslinking | 1.00E−03 | 1.30E−03 | 1.15E−03 | 1.00E−03 | 1.00E−03 | 9.00E−04 | 1.00E−03 |
| | | | density (mol/m³) | | | | | | | |
| | Back | Polyol | Type | PEPO | PEPO | PEPO | PEPO | PEPO | PEPO | PEPO |
| | surface | | Molecular weight | 1000 | 1000 | 1000 | 500 | 500 | 1000 | 500 |
| | layer | | Molar ratio | 84 | 84 | 84 | 83.5 | 83.5 | 84 | 83.5 |
| | | | (mol %) | | | | | | | |
| | | Crosslinking | Type | TMP | TMP | TMP | TMP | TMP | TMP | TMP |
| | | agent | Molar ratio | 1 | 1 | 1 | 1.5 | 1.5 | 1 | 1.5 |
| | | | (mol %) | | | | | | | |
| | | Isocyanate | Type | MDI | MDI | MDI | MDI | MDI | MDI | MDI |
| | | | Molar ratio | 15 | 15 | 15 | 15 | 15 | 15 | 15 |
| | | | (mol %) | | | | | | | |
| | | Characteristics | 100% Modulus | 5 | 5 | 5 | 3 | 3 | 5 | 3 |
| | | | (MPa) | | | | | | | |
| | | | Permanent | 0.5 | 0.5 | 0.5 | 0.4 | 0.4 | 0.5 | 0.4 |
| | | | elongation (%) | | | | | | | |
| | | | Crosslinking | 1.50E−03 | 1.50E−03 | 1.50E−03 | 2.00E−03 | 2.00E−03 | 1.50E−03 | 2.00E−03 |
| | | | density (mol/m³) | | | | | | | |

| | | | | | | | |
|---|---|---|---|---|---|---|---|
| Abrasion resistance of image | 2 | 3 | 4 | 3 | 4 | 3 | 3 |
| Photoluminescence | 4 | 3 | 4 | 3 | 2 | 4 | 3 |
| Wear amount of blade (μm²) | 1.5 | 2.5 | 2 | 1.5 | 1 | 1.5 | 1.5 |
| Toner leakage | A | A | A | A | A | A | B |
| Image evaluation | A | A | A | A | A | A | B |

TABLE 2

| | | | | Example | Example | Example | Example | Example | Example | Example |
|---|---|---|---|---|---|---|---|---|---|---|
| | | | | 8 | 9 | 10 | 11 | 12 | 13 | 14 |
| Toner particles | | Average equivalent circle diameter | | 15 | 5 | 15 | 15 | 15 | 15 | 15 |
| | | of pigment (μm) | | | | | | | | |
| | | Amount of crystalline resin (% by | | 30 | 3 | 3 | 3 | 3 | 3 | 3 |
| | | mass ) | | | | | | | | |
| | | Average value of ratio (b/a) | | 0.8 | 0.5 | 0.5 | 0.5 | 0.5 | 0.5 | 0.5 |
| | | Average value of pigment area ratio | | 0.7 | 0.5 | 0.7 | 0.7 | 0.7 | 0.7 | 0.7 |
| Cleaning | Front | Polyol | Type | PEPO | PEPO | PEPO | PEPO | PEPO | PEPO | PEPO |
| blade | surface | | Molecular | 8000 | 1000 | 10000 | 10000 | 10000 | 10000 | 5000 |
| | layer | | weight | | | | | | | |
| | | | Molar ratio | 64.2 | 60.5 | 64.2 | 88.8 | 83.8 | 68.8 | 58.2 |
| | | | (mol %) | | | | | | | |
| | | Crosslinking | Type | TMP | TMP | TMP | TMP | TMP | TMP | TMP |
| | | agent | Molar ratio | 0.8 | 1.5 | 0.8 | 1.2 | 1.2 | 1.2 | 1.8 |
| | | | (mol %) | | | | | | | |
| | | Isocyanate | Type | MDI | MDI | MDI | MDI | MDI | MDI | MDI |
| | | | Molar ratio | 35 | 38 | 35 | 10 | 15 | 30 | 40 |
| | | | (mol %) | | | | | | | |
| | | Characteristics | Breaking energy | 10000 | 5000 | 12000 | 7500 | 8500 | 10000 | 6500 |
| | | | (MPa · %) | | | | | | | |
| | | | 100% Modulus | 15 | 11 | 16 | 10 | 12 | 15 | 11 |
| | | | (MPa) | | | | | | | |
| | | | Crosslinking | 1.00E−03 | 1.30E−03 | 1.00E−03 | 9.50E−04 | 1.00E−03 | 1.15E−03 | 1.50E−03 |
| | | | density (mol/m³) | | | | | | | |
| | Back | Polyol | Type | PEPO | PEPO | PEPO | PEPO | PEPO | PEPO | PEPO |
| | surface | | Molecular | 2000 | 1000 | 1000 | 1000 | 1000 | 1000 | 1000 |
| | layer | | weight | | | | | | | |
| | | | Molar ratio | 69.2 | 84 | 84 | 84 | 84 | 84 | 84 |
| | | | (mol %) | | | | | | | |
| | | Crosslinking | Type | TMP | TMP | TMP | TMP | TMP | TMP | TMP |
| | | agent | Molar ratio | 0.8 | 1 | 1 | 1 | 1 | 1 | 1 |
| | | | (mol %) | | | | | | | |
| | | Isocyanate | Type | MDI | MDI | MDI | MDI | MDI | MDI | MDI |
| | | | Molar ratio | 30 | 15 | 15 | 15 | 15 | 15 | 15 |
| | | | (mol %) | | | | | | | |
| | | Characteristics | 100% Modulus | 8 | 5 | 5 | 5 | 5 | 5 | 5 |
| | | | (MPa) | | | | | | | |
| | | | Permanent | 3.0 | 0.5 | 0.5 | 0.5 | 0.5 | 0.5 | 0.5 |
| | | | elongation (%) | | | | | | | |
| | | | Crosslinking | 2.50E−03 | 1.50E−03 | 1.50E−03 | 1.50E−03 | 1.50E−03 | 1.50E−03 | 1.50E−03 |
| | | | density (mol/m³) | | | | | | | |

| | | | | | | | |
|---|---|---|---|---|---|---|---|
| Abrasion resistance of image | 3 | 3 | 2 | 2 | 2 | 2 | 2 |
| Photoluminescence | 3 | 3 | 4 | 4 | 4 | 4 | 4 |
| Wear amount of blade (μm²) | 2 | 2.8 | 1 | 2.8 | 2.3 | 1.5 | 2.5 |
| Toner leakage | B | B | A | B | B | A | B |
| Image evaluation | B | B | A | B | B | A | B |

TABLE 3

| | | | | Example | Example | Example | Example | Example | Example | Example |
|---|---|---|---|---|---|---|---|---|---|---|
| | | | | 15 | 16 | 17 | 18 | 19 | 20 | 21 |
| Toner particles | | Average equivalent circle diameter | | 15 | 15 | 15 | 15 | 15 | 15 | 15 |
| | | of pigment (μm) | | | | | | | | |
| | | Amount of crystalline resin (% by | | 3 | 3 | 3 | 3 | 3 | 3 | 35 |
| | | mass) | | | | | | | | |
| | | Average value of ratio (b/a) | | 0.5 | 0.5 | 0.5 | 0.5 | 0.5 | 0.5 | 0.5 |
| | | Average value of pigment area ratio | | 0.7 | 0.7 | 0.7 | 0.7 | 0.7 | 0.7 | 0.7 |
| Cleaning | Front | Polyol | Type | PEPO | PEPO | PEPO | PEPO | PEPO | PEPO | PEPO |
| blade | surface | | Molecular | 8000 | 8000 | 8000 | 8000 | 8000 | 8000 | 8000 |
| | layer | | weight | | | | | | | |
| | | | Molar ratio | 64.2 | 64.2 | 64.2 | 64.2 | 64.2 | 64.2 | 64.2 |
| | | | (mol %) | | | | | | | |
| | | Crosslinking | Type | TMP | TMP | TMP | TMP | TMP | TMP | TMP |
| | | agent | Molar ratio | 0.8 | 0.8 | 0.8 | 0.8 | 0.8 | 0.8 | 0.8 |
| | | | (mol %) | | | | | | | |
| | | Isocyanate | Type | MDI | MDI | MDI | MDI | MDI | MDI | MDI |
| | | | Molar ratio | 35 | 35 | 35 | 35 | 35 | 35 | 35 |
| | | | (mol %) | | | | | | | |
| | | Characteristics | Breaking energy | 10000 | 10000 | 10000 | 10000 | 10000 | 10000 | 10000 |
| | | | (MPa · %) | | | | | | | |
| | | | 100% Modulus | 15 | 15 | 15 | 15 | 15 | 15 | 15 |
| | | | (MPa) | | | | | | | |
| | | | Crosslinking | 1.00E−03 | 1.00E−03 | 1.00E−03 | 1.00E−03 | 1.00E−03 | 1.00E−03 | 1.00E−03 |
| | | | density (mol/m³) | | | | | | | |
| | Back | Polyol | Type | PEPO | PEPO | PEPO | PEPO | PEPO | PEPO | PEPO |
| | surface | | Molecular | 1000 | 500 | 1000 | 100 | 80 | 2500 | 1000 |
| | layer | | weight | | | | | | | |
| | | | Molar ratio | 79 | 85.5 | 84.4 | 76.2 | 73 | 84 | 84 |
| | | | (mol %) | | | | | | | |
| | | Crosslinking | Type | TMP | TMP | TMP | TMP | TMP | TMP | TMP |
| | | agent | Molar ratio | 1 | 1.5 | 0.6 | 1.8 | 2 | 1 | 1 |
| | | | (mol %) | | | | | | | |
| | | Isocyanate | Type | MDI | MDI | MDI | MDI | MDI | MDI | MDI |
| | | | Molar ratio | 20 | 13 | 15 | 22 | 25 | 15 | 15 |
| | | | (mol %) | | | | | | | |
| | | Characteristics | 100% Modulus | 7 | 2 | 5 | 2 | 2 | 8 | 5 |
| | | | (MPa) | | | | | | | |
| | | | Permanent | 1.8 | 0.6 | 1.0 | 0.4 | 0.3 | 0.7 | 0.5 |
| | | | elongation (%) | | | | | | | |
| | | | Crosslinking | 1.80E−03 | 1.60E−03 | 1.30E−03 | 2.60E−03 | 3.00E−03 | 1.00E−03 | 1.50E−03 |
| | | | density (mol/m³) | | | | | | | |

| | | | | | | | |
|---|---|---|---|---|---|---|---|
| Abrasion resistance of image | 2 | 2 | 2 | 2 | 2 | 2 | 4 |
| Photoluminescence | 4 | 4 | 4 | 4 | 4 | 4 | 2 |
| Wear amount of blade (μm²) | 1.8 | 2.1 | 1.5 | 2 | 2 | 2.1 | 1.8 |
| Toner leakage | B | B | B | B | B | B | A |
| Image evaluation | B | B | B | B | B | B | A |

TABLE 4

| | | | | Compar- | Compar- | Compar- | Compar- | Compar- | Compar- | Compar- |
|---|---|---|---|---|---|---|---|---|---|---|
| | | | | ative | ative | ative | ative | ative | ative | ative |
| | | | | Example 1 | Example 2 | Example 3 | Example 4 | Example 5 | Example 6 | Example 7 |
| Toner particles | | Average equivalent circle diameter | | 15 | 15 | 15 | 5 | 15 | 5 | 5 |
| | | of pigment (μm) | | | | | | | | |
| | | Amount of crystalline resin (% by | | 3 | 30 | 1 | 1 | 1 | 3 | 3 |
| | | mass) | | | | | | | | |
| | | Average value of ratio (b/a) | | 0.5 | 0.8 | 0.4 | 0.4 | 0.4 | 0.5 | 0.5 |
| | | Average value of pigment area | | 0.7 | 0.7 | 0.7 | 0.5 | 0.7 | 0.5 | 0.5 |
| | | ratio | | | | | | | | |
| Cleaning | Front | Polyol | Type | PEPO | PEPO | PEPO | PEPO | PEPO | PEPO | PEPO |
| blade | surface | | Molecular | 1500 | 9000 | 5000 | 5000 | 1500 | 2000 | 2000 |
| | layer | | weight | | | | | | | |
| | | | Molar ratio | 88.5 | 54.5 | 64 | 64 | 88.5 | 62.5 | 68.7 |
| | | | (mol %) | | | | | | | |
| | | Crosslinking | Type | TMP | TMP | TMP | TMP | TMP | TMP | TMP |
| | | agent | Molar ratio | 2 | 0.5 | 1 | 1 | 2 | 2.5 | 1.3 |
| | | | (mol %) | | | | | | | |
| | | Isocyanate | Type | MDI | MDI | MDI | MDI | MDI | MDI | MDI |
| | | | Molar ratio | 9.5 | 45 | 35 | 35 | 9.5 | 35 | 30 |
| | | | (mol %) | | | | | | | |
| | | Characteristics | Breaking | 4000 | 18000 | 8200 | 8200 | 4000 | 3500 | 5000 |
| | | | energy | | | | | | | |
| | | | (MPa · %) | | | | | | | |
| | | | 100% Modulus | 5 | 23 | 12 | 12 | 5 | 10 | 9 |
| | | | (MPa) | | | | | | | |
| | | | Crosslinking | 2.00E−03 | 8.00E−04 | 1.15E−03 | 1.15E−03 | 2.00E−03 | 2.30E−03 | 8.00E−04 |
| | | | density | | | | | | | |
| | | | (mol/m³) | | | | | | | |
| | Back | Polyol | Type | PEPO | PEPO | PEPO | PEPO | PEPO | PEPO | PEPO |
| | surface | | Molecular | 1000 | 500 | 1000 | 1000 | 1000 | 1000 | 1000 |
| | layer | | weight | | | | | | | |
| | | | Molar ratio | 84 | 83.5 | 84 | 84 | 84 | 84 | 84 |
| | | | (mol %) | | | | | | | |
| | | Crosslinking | Type | TMP | TMP | TMP | TMP | TMP | TMP | TMP |
| | | agent | Molar ratio | 1 | 1.5 | 1 | 1 | 1 | 1 | 1 |
| | | | (mol %) | | | | | | | |
| | | Isocyanate | Type | MDI | MDI | MDI | MDI | MDI | MDI | MDI |
| | | | Molar ratio | 15 | 15 | 15 | 15 | 15 | 15 | 15 |
| | | | (mol %) | | | | | | | |
| | | Characteristics | 100% Modulus | 5 | 3 | 5 | 5 | 5 | 5 | 5 |
| | | | (MPa) | | | | | | | |
| | | | Permanent | 0.5 | 0.4 | 0.5 | 0.5 | 0.5 | 0.5 | 0.5 |
| | | | elongation (%) | | | | | | | |
| | | | Crosslinking | 1.50E−03 | 2.00E−03 | 1.50E−03 | 1.50E−03 | 1.50E−03 | 1.50E−03 | 1.50E−03 |
| | | | density | | | | | | | |
| | | | (mol/m³) | | | | | | | |

| | | | | | | | |
|---|---|---|---|---|---|---|---|
| Abrasion resistance of image | 2 | 3 | 1 | 1 | 1 | 3 | 3 |
| Photoluminescence | 4 | 1 | 4 | 3 | 4 | 3 | 3 |
| Wear amount of blade (μm²) | 10 | 6.5 | 2.5 | 2.5 | 13 | 12 | 3 |
| Toner leakage | C | C | A | A | C | C | C |
| Image evaluation | C | C | A | A | C | C | C |

As shown in Tables 1 to 4, in Examples 1 to 21, both the toner particles and the cleaning blade satisfy the requirements according to the present exemplary embodiment. In Examples 1 to 21, a toner having excellent photoluminescence (that is, a toner in which high brightness and high reflectivity are exhibited and a metallic feeling with a high concealing power is reproduced) is obtained. In addition, the cleaning blade has excellent mechanical strength and abrasion resistance, and favorable cleaning properties with the above-described toner difficult to clean are obtained for a long period of time even in a case of having a flat shape.

In Comparative Example 1, since the breaking energy and the 100% modulus of the cleaning blade are low, the cleaning blade is worn out and the mechanical stiffness is weak. In Comparative Example 1, the behavior of the blade is unstable, the toner leakage occurs, and the image evaluation is poor.

In Comparative Example 2, since the breaking energy of the cleaning blade is high, the contact pressure with the image holder is high, and the cleaning blade is worn out. In Comparative Example 2, the toner leakage occurs, and the image evaluation is poor.

In Comparative Examples 3 and 4, the average value of the ratio b/a of the minor axis diameter b to the major axis diameter a in the cross section of the toner particles is low. In Comparative Examples 3 and 4, the coating property and the abrasion resistance of the metal pigment by the binder resin in the toner particles are low, and the abrasion resistance of the image is poor.

In Comparative Example 5, since the breaking energy and the 100% modulus of the cleaning blade are low, the cleaning blade is worn out and the mechanical stiffness is weak. In addition, in Comparative Example 5, the average value of the ratio b/a of the minor axis diameter b to the major axis diameter a in the cross section of the toner particles is low. In Comparative Example 5, the behavior of the blade is unstable, the toner leakage occurs, and the image evaluation is poor. Furthermore, the coating property and the abrasion resistance of the metal pigment by the binder resin in the toner particles are low, and the abrasion resistance of the image is poor.

In Comparative Example 6, the breaking energy of the cleaning blade is low, and the cleaning blade is worn out. In Comparative Example 6, the behavior of the blade is unstable, the toner leakage occurs, and the image evaluation is poor.

In Comparative Example 7, the 100% modulus of the cleaning blade is low, the behavior of the blade is unstable, the toner leakage occurs, and the image evaluation is poor.

Supplementary Notes

(((1)))

An image forming apparatus comprising:
an image holder;
a charging unit that charges a surface of the image holder;
an electrostatic charge image forming unit that forms an electrostatic charge image on the charged surface of the image holder;
an electrostatic charge image developing unit that has an electrostatic charge image developing toner containing toner particles and develops the electrostatic image with the electrostatic charge image developing toner to form a toner image, in which the toner particles contain a metal pigment having an average equivalent circle diameter of 5 μm or more and 15 μm or less, an average value of a ratio b/a of a minor axis diameter b to a major axis diameter a in a cross section of the toner particles is 0.5 or more and 0.8 or less, and an average value of an area of the metal pigment in a projection image of the toner particles in a case where the toner particles are viewed from a thickness direction is 0.5 or more and 0.7 or less;
a transferring unit that transfers the toner image to a recording medium; and
a cleaning unit that has a cleaning blade coming into contact with the surface of the image holder to clean the surface, in which the cleaning blade has a breaking energy of 5000 MPa·% or more and 15000 MPa·% or less and has a 100% modulus of 10 MPa or more at a contact portion with the image holder.
   (((2)))

The image forming apparatus according to (((1))), wherein the breaking energy of the cleaning blade is 7000 MPa % or more and 12000 MPa·% or less.

(((3)))

The image forming apparatus according to (((1))) or (((2))),
wherein the 100% modulus of the cleaning blade at the contact portion with the image holder is 12 MPa or more and 20 MPa or less.
   (((4)))

The image forming apparatus according to any one of (((1))) to (((3))),
wherein, in the cleaning blade, a material constituting the contact portion with the image holder is a polyurethane in which a polyester polyol having a weight-average molecular weight of 1000 or more and 10000 or less, an isocyanate compound, a crosslinking agent are polymerized.
   (((5)))

The image forming apparatus according to (((4))),
wherein the weight-average molecular weight of the polyester polyol is 2000 or more and 8000 or less.
   (((6)))

The image forming apparatus according to any one of (((1))) to (5)
wherein, in the cleaning blade, a material constituting the contact portion with the image holder is a polyurethane in which a polyol, an isocyanate compound, and a crosslinking agent are polymerized, and a proportion of the isocyanate compound in the material constituting the contact portion is 10 mol % or more and 40 mol % or less.
   (((7)))

The image forming apparatus according to (((6))),
wherein the proportion of the isocyanate compound in the material constituting the contact portion is 15 mol % or more and 30 mol % or less.
   (((8)))

The image forming apparatus according to any one of (((1) to ((7))
wherein, in the cleaning blade, a material constituting the contact portion with the image holder is a polyurethane in which a polyol, an isocyanate compound, and a crosslinking agent are polymerized, and a crosslinking density is 0.90×10⁻³ mol/m³ or more and 1.50×10⁻³ mol/m³ or less.
   (((9)))

The image forming apparatus according to (((8))),
wherein the crosslinking density is 1.00×10⁻³ mol/m³ or more and 1.30×10⁻³ mol/m³ or less.
   (((10)))

The image forming apparatus according to any one of (((1))) to (((9))),
wherein the cleaning blade has a front surface layer that comes into contact with the image holder and a back surface layer that is disposed on an opposite side of the image holder with respect to the front surface layer, and
the back surface layer has a 100% modulus of 3 MPa or more and 7 MPa or less and a permanent elongation of less than 2.0%.
   (((11)))

The image forming apparatus according to (((10))),
wherein the 100% modulus of the back surface layer is 4 MPa or more and 6 MPa or less.
   (((12)))

The image forming apparatus according to (((10))) or (((11))),
wherein the permanent elongation of the back surface layer is 1.0% or less.
   (((13)))

The image forming apparatus according to any one of (((1))) to ((12))),
wherein the cleaning blade has a front surface layer that comes into contact with the image holder and a back surface layer that is disposed on an opposite side of the image holder with respect to the front surface layer, and
a material constituting the back surface layer is a polyurethane in which a polyester polyol having a weight-average molecular weight of 100 or more and 2000 or less, an isocyanate compound, a crosslinking agent are polymerized.
   (((14)))

The image forming apparatus according to (((13))),
wherein the weight-average molecular weight of the polyester polyol is 500 or more and 1000 or less.
   (((15)))

The image forming apparatus according to any one of (((1))) to (((14))),
wherein the cleaning blade has a front surface layer that comes into contact with the image holder and a back surface layer that is disposed on an opposite side of the image holder with respect to the front surface layer, and
a material constituting the back surface layer is a polyurethane in which a polyol, an isocyanate compound, and a crosslinking agent are polymerized, and a proportion of the isocyanate compound in the material constituting the back surface layer is 5 mol % or more and 20 mol % or less.
   (((16)))

The image forming apparatus according to (((15))),
wherein the proportion of the isocyanate compound in the material constituting the back surface layer is 5 mol % or more and 15 mol % or less.
   (((17)))

The image forming apparatus according to any one of (((1)) to (16)
wherein the cleaning blade has a front surface layer that comes into contact with the image holder and a back surface layer that is disposed on an opposite side of the image holder with respect to the front surface layer, and
a material constituting the back surface layer is a polyurethane in which a polyol, an isocyanate compound, and a crosslinking agent are polymerized, and a crosslinking density is 1.5×10⁻³ mol/m³ or more and 2.5×10-3 mol/m³ or less.
   (((18)))

The image forming apparatus according to (((17))),
wherein the crosslinking density is 1.8×10⁻³ mol/m³ or more and 2.2×10⁻³ mol/m³ or less.
   (((19)))

The image forming apparatus according to any one of (((1))) to (((18))),
wherein the toner particles contain a binder resin including a crystalline resin and an amorphous resin, and
a proportion of the crystalline resin in the binder resin is 3% by mass or more and 30% by mass or less.
   (((20)))

The image forming apparatus according to (((19))),
wherein the proportion of the crystalline resin in the binder resin is 5% by mass or more and 25% by mass or less.
   (((21)))

An image forming method comprising:
charging a surface of an image holder;
forming an electrostatic charge image on the charged surface of the image holder;
forming a toner image by developing the electrostatic charge image with an electrostatic charge image developing toner containing toner particles, in which the toner particles contain a metal pigment having an average equivalent circle diameter of 5 μm or more and 15 μm or less, an average value of a ratio b/a of a minor axis diameter b to a major axis diameter a in a cross section of the toner particles is 0.5 or more and 0.8 or less, and an average value of an area of the metal pigment in a projection image of the toner particles in a case where the toner particles are viewed from a thickness direction is 0.5 or more and 0.7 or less;
transferring the toner image to a recording medium; and
bringing a cleaning blade into contact with the surface of the image holder to clean the surface, in which the cleaning blade has a breaking energy of 5000 MPa % or more and 15000 MPa·% or less and has a 100% modulus of 10 MPa or more at a contact portion with the image holder.

The foregoing description of the exemplary embodiments of the present invention has been provided for the purposes of illustration and description. It is not intended to be exhaustive or to limit the invention to the precise forms disclosed. Obviously, many modifications and variations will be apparent to practitioners skilled in the art. The embodiments were chosen and described in order to best explain the principles of the invention and its practical applications, thereby enabling others skilled in the art to understand the invention for various embodiments and with the various modifications as are suited to the particular use contemplated. It is intended that the scope of the invention be defined by the following claims and their equivalents.

What is claimed is:

1. An image forming apparatus comprising:
an image holder;
a charging unit that charges a surface of the image holder;
an electrostatic charge image forming unit that forms an electrostatic charge image on the charged surface of the image holder;
an electrostatic charge image developing unit that has an electrostatic charge image developing toner containing toner particles and develops the electrostatic image with the electrostatic charge image developing toner to form a toner image, in which the toner particles contain a metal pigment having an average equivalent circle diameter of 5 μm or more and 15 μm or less, an average value of a ratio b/a of a minor axis diameter b to a major axis diameter a in a cross section of the toner particles is 0.5 or more and 0.8 or less, and an average value of an area of the metal pigment in a projection image of the toner particles in a case where the toner particles are viewed from a thickness direction is 0.5 or more and 0.7 or less;
a transferring unit that transfers the toner image to a recording medium; and
a cleaning unit that has a cleaning blade coming into contact with the surface of the image holder to clean the surface, in which the cleaning blade has a breaking energy of 5000 MPa·% or more and 15000 MPa % or less and has a 100% modulus of 10 MPa or more at a contact portion with the image holder.

2. The image forming apparatus according to claim 1,
wherein the breaking energy of the cleaning blade is 7000 MPa % or more and 12000 MPa·% or less.

3. The image forming apparatus according to claim 1,
wherein the 100% modulus of the cleaning blade at the contact portion with the image holder is 12 MPa or more and 20 MPa or less.

4. The image forming apparatus according to claim 1,
wherein, in the cleaning blade, a material constituting the contact portion with the image holder is a polyurethane in which a polyester polyol having a weight-average molecular weight of 1000 or more and 10000 or less, an isocyanate compound, a crosslinking agent are polymerized.

5. The image forming apparatus according to claim 4,
wherein the weight-average molecular weight of the polyester polyol is 2000 or more and 8000 or less.

6. The image forming apparatus according to claim 1,
wherein, in the cleaning blade, a material constituting the contact portion with the image holder is a polyurethane in which a polyol, an isocyanate compound, and a crosslinking agent are polymerized, and a proportion of the isocyanate compound in the material constituting the contact portion is 10 mol % or more and 40 mol % or less.

7. The image forming apparatus according to claim 6,
wherein the proportion of the isocyanate compound in the material constituting the contact portion is 15 mol % or more and 30 mol % or less.

8. The image forming apparatus according to claim 1,
wherein, in the cleaning blade, a material constituting the contact portion with the image holder is a polyurethane in which a polyol, an isocyanate compound, and a crosslinking agent are polymerized, and a crosslinking density is 0.90×10⁻³ mol/m³ or more and 1.50×10⁻³ mol/m³ or less.

9. The image forming apparatus according to claim 8,
wherein the crosslinking density is 1.00×10⁻³ mol/m³ or more and 1.30×10⁻³ mol/m³ or less.

10. The image forming apparatus according to claim 1,
wherein the cleaning blade has a front surface layer that comes into contact with the image holder and a back surface layer that is disposed on an opposite side of the image holder with respect to the front surface layer, and
the back surface layer has a 100% modulus of 3 MPa or more and 7 MPa or less and a permanent elongation of less than 2.0%.

11. The image forming apparatus according to claim 10,
wherein the 100% modulus of the back surface layer is 4 MPa or more and 6 MPa or less.

12. The image forming apparatus according to claim 10,
wherein the permanent elongation of the back surface layer is 1.0% or less.

13. The image forming apparatus according to claim 1,
wherein the cleaning blade has a front surface layer that comes into contact with the image holder and a back surface layer that is disposed on an opposite side of the image holder with respect to the front surface layer, and
a material constituting the back surface layer is a polyurethane in which a polyester polyol having a weight-average molecular weight of 100 or more and 2000 or less, an isocyanate compound, a crosslinking agent are polymerized.

14. The image forming apparatus according to claim 13,
wherein the weight-average molecular weight of the polyester polyol is 500 or more and 1000 or less.

15. The image forming apparatus according to claim 1,
wherein the cleaning blade has a front surface layer that comes into contact with the image holder and a back surface layer that is disposed on an opposite side of the image holder with respect to the front surface layer, and
a material constituting the back surface layer is a polyurethane in which a polyol, an isocyanate compound, and a crosslinking agent are polymerized, and a proportion of the isocyanate compound in the material constituting the back surface layer is 5 mol % or more and 20 mol % or less.

16. The image forming apparatus according to claim 15,
wherein the proportion of the isocyanate compound in the material constituting the back surface layer is 5 mol % or more and 15 mol % or less.

17. The image forming apparatus according to claim 1,
wherein the cleaning blade has a front surface layer that comes into contact with the image holder and a back surface layer that is disposed on an opposite side of the image holder with respect to the front surface layer, and
a material constituting the back surface layer is a polyurethane in which a polyol, an isocyanate compound, and a crosslinking agent are polymerized, and a crosslinking density is 1.5×10⁻³ mol/m³ or more and 2.5×10⁻³ mol/m³ or less.

18. The image forming apparatus according to claim 17,
wherein the crosslinking density is 1.8×10⁻³ mol/m³ or more and 2.2×10⁻³ mol/m³ or less.

19. The image forming apparatus according to claim 1,
wherein the toner particles contain a binder resin including a crystalline resin and an amorphous resin, and
a proportion of the crystalline resin in the binder resin is 3% by mass or more and 30% by mass or less.

20. An image forming method comprising:
charging a surface of an image holder;
forming an electrostatic charge image on the charged surface of the image holder;
forming a toner image by developing the electrostatic charge image with an electrostatic charge image developing toner containing toner particles, in which the toner particles contain a metal pigment having an average equivalent circle diameter of 5 μm or more and 15 μm or less, an average value of a ratio b/a of a minor axis diameter b to a major axis diameter a in a cross section of the toner particles is 0.5 or more and 0.8 or less, and an average value of an area of the metal pigment in a projection image of the toner particles in a case where the toner particles are viewed from a thickness direction is 0.5 or more and 0.7 or less;
transferring the toner image to a recording medium; and
bringing a cleaning blade into contact with the surface of the image holder to clean the surface, in which the cleaning blade has a breaking energy of 5000 MPa % or more and 15000 MPa·% or less and has a 100% modulus of 10 MPa or more at a contact portion with the image holder.
